(19) United States
(12) Patent Application Publication
(10) Pub. No.: US 2025/0321464 A1
(43) Pub. Date: Oct. 16, 2025

(54) IMAGING LENS DRIVING MODULE, CAMERA MODULE AND ELECTRONIC DEVICE

(71) Applicant: LARGAN DIGITAL CO.,LTD., Taichung City (TW)

(72) Inventors: Yu-Tzu CHANG, Taichung City (TW); Heng Yi SU, Taichung City (TW)

(73) Assignee: LARGAN DIGITAL CO.,LTD., Taichung City (TW)

(21) Appl. No.: 18/923,202

(22) Filed: Oct. 22, 2024

Related U.S. Application Data
(60) Provisional application No. 63/632,436, filed on Apr. 10, 2024.

(51) Int. Cl. G03B 13/36; G03B 30/00

(52) U.S. Cl. CPC G03B 13/36; G03B 30/00

(57) ABSTRACT

An imaging lens driving module includes an imaging lens having an optical axis, a lens carrier mounting the imaging lens, a base disposed corresponding to the lens carrier, balls and a driving unit configured to move the lens carrier with respect to the base along a direction parallel to the optical axis. The lens carrier includes first and second guiding tracks each extending along a direction parallel to the optical axis. The base includes third and fourth guiding tracks each extending along a direction parallel to the optical axis. The third guiding track is disposed corresponding to the first guiding track. The fourth guiding track is disposed corresponding to the second guiding track. The balls include a first ball disposed between the first guiding track and the third guiding track and a second ball disposed between the second guiding track and the fourth guiding track.

### RELATED APPLICATIONS

This application claims priority to U.S. Provisional Application 63/632,436, filed on Apr. 10, 2024, which is incorporated by reference herein in its entirety.

### BACKGROUND

### Technical Field

The present disclosure relates to an imaging lens driving module, a camera module and an electronic device, more particularly to an imaging lens driving module and a camera module applicable to an electronic device.

### Description of Related Art

With the development of technology, featuring high image quality becomes one of the indispensable features of an optical system nowadays. Furthermore, electronic devices equipped with optical systems are trending towards multi-functionality for various applications, and therefore the functionality requirements for the optical systems have been increasing.

However, conventional optical lenses are difficult to meet the requirements of high optical quality of an electronic device under diversified development in recent years, particularly concerning the movement stability requirements in the market of the current technology trends. Therefore, how to improve the mechanism employed for moving an optical lens to meet the stringent requirements of high-end-specification electronic devices is an important topic in this field nowadays.

### SUMMARY

According to one aspect of the present disclosure, an imaging lens driving module includes an imaging lens, a lens carrier, a base, a plurality of balls and a driving unit. The imaging lens has an optical axis. The lens carrier is configured to mount the imaging lens. The lens carrier includes a first guiding track and a second guiding track. The first guiding track extends along a direction parallel to the optical axis. The first guiding track has a first surface and a second surface. The first surface and the second surface are connected to each other, and the first surface is angled to the second surface. The second guiding track extends along a direction parallel to the optical axis. The second guiding track has a third surface and a fourth surface. The third surface and the fourth surface are connected to each other, and the third surface is angled to the fourth surface. The base is disposed corresponding to the lens carrier. The base includes a third guiding track and a fourth guiding track. The third guiding track extends along a direction parallel to the optical axis. The third guiding track is disposed corresponding to the first guiding track. The third guiding track has a fifth surface and a sixth surface. The fifth surface and the sixth surface are connected to each other, and the fifth surface is angled to the sixth surface. The fourth guiding track extends along a direction parallel to the optical axis. The fourth guiding track is disposed corresponding to the second guiding track. The fourth guiding track has a seventh surface and an eighth surface. The seventh surface and the eighth surface are connected to each other, and the seventh surface is angled to the eighth surface. The balls are disposed between the lens carrier and the base. The balls include at least one first ball and at least one second ball. The at least one first ball is disposed between the first guiding track and the third guiding track. The at least one second ball is disposed between the second guiding track and the fourth guiding track. The driving unit is configured to move the lens carrier with respect to the base along a direction parallel to the optical axis. The driving unit includes at least one magnet and at least one coil. The at least one magnet and the at least on coil are disposed corresponding to each other. One of the at least one magnet and the at least one coil is coupled to the lens carrier. Each of the first surface through the eighth surface is in physical contact with correspondingly disposed one among the balls through only one contact point. When an angle between the second surface and the fourth surface is θ, the following condition is satisfied: 0°≤θ<130°.

According to another aspect of the present disclosure, an imaging lens driving module includes an imaging lens, a lens carrier, a base, a plurality of balls and a driving unit. The imaging lens has an optical axis. The lens carrier is configured to mount the imaging lens. The lens carrier includes a first guiding track and a second guiding track. The first guiding track extends along a direction parallel to the optical axis. The first guiding track has a first surface and a second surface. The first surface and the second surface are connected to each other, and the first surface is angled to the second surface. The second guiding track extends along a direction parallel to the optical axis. The second guiding track has a third surface and a fourth surface. The third surface and the fourth surface are connected to each other, and the third surface is angled to the fourth surface. The base is disposed corresponding to the lens carrier. The base includes a third guiding track and a fourth guiding track. The third guiding track extends along a direction parallel to the optical axis. The third guiding track is disposed corresponding to the first guiding track. The third guiding track has a fifth surface and a sixth surface. The fifth surface and the sixth surface are connected to each other, and the fifth surface is angled to the sixth surface. The fourth guiding track extends along a direction parallel to the optical axis. The fourth guiding track is disposed corresponding to the second guiding track. The fourth guiding track has a seventh surface and an eighth surface. The seventh surface and the eighth surface are connected to each other, and the seventh surface is angled to the eighth surface. The balls are disposed between the lens carrier and the base. The balls include at least one first ball and at least one second ball. The at least one first ball is disposed between the first guiding track and the third guiding track. The at least one second ball is disposed between the second guiding track and the fourth guiding track. The driving unit is configured to move the lens carrier with respect to the base along a direction parallel to the optical axis. The driving unit includes at least one magnet and at least one coil. The at least one magnet and the at least one coil are disposed corresponding to each other. One of the at least one magnet and the at least one coil is coupled to the lens carrier. Each of the first surface through the eighth surface is in physical contact with correspondingly disposed one among the balls through only one contact point. When an angle between the sixth surface and the eighth surface is θ′, the following condition is satisfied: 0°≤θ′<130°.

According to another aspect of the present disclosure, an imaging lens driving module includes an imaging lens, a lens carrier, a base, a plurality of balls and a driving unit. The imaging lens has an optical axis. The lens carrier is configured to mount the imaging lens. The lens carrier includes a first guiding track and a second guiding track. The first guiding track extends along a direction parallel to the optical axis. The first guiding track has a first surface and a second surface. The first surface and the second surface are connected to each other, and the first surface is angled to the second surface. The second guiding track extends along a direction parallel to the optical axis. The second guiding track has a third surface and a fourth surface. The third surface and the fourth surface are connected to each other, and the third surface is angled to the fourth surface. The base is disposed corresponding to the lens carrier. The base includes a third guiding track and a fourth guiding track. The third guiding track extends along a direction parallel to the optical axis. The third guiding track is disposed corresponding to the first guiding track. The third guiding track has a fifth surface and a sixth surface. The fifth surface and the sixth surface are connected to each other, and the fifth surface is angled to the sixth surface. The fourth guiding track extends along a direction parallel to the optical axis. The fourth guiding track is disposed corresponding to the second guiding track. The fourth guiding track has a seventh surface and an eighth surface. The seventh surface and the eighth surface are connected to each other, and the seventh surface is angled to the eighth surface. The balls are disposed between the lens carrier and the base. The balls include at least one first ball and at least one second ball. The at least one first ball is disposed between the first guiding track and the third guiding track. The at least one second ball is disposed between the second guiding track and the fourth guiding track. The driving unit is configured to move the lens carrier with respect to the base along a direction parallel to the optical axis. The driving unit includes at least one magnet and at least one coil. The at least one magnet and the at least one coil are disposed corresponding to each other. One of the at least one magnet and the at least one coil is coupled to the lens carrier. Each of the first surface through the eighth surface is in physical contact with correspondingly disposed one among the balls through only one contact point.

According to another aspect of the present disclosure, a camera module includes one of the aforementioned imaging lens driving modules.

According to another aspect of the present disclosure, an electronic device includes the aforementioned camera module and an image sensor, wherein the image sensor is disposed on an image surface of the camera module.

### BRIEF DESCRIPTION OF THE DRAWINGS

The disclosure can be better understood by reading the following detailed description of the embodiments, with reference made to the accompanying drawings as follows:

FIG. 1 is a perspective view of a camera module according to the 1st embodiment of the present disclosure;

FIG. 2 is an exploded view of the camera module in FIG. 1;

FIG. 3 is another exploded view of the camera module in FIG. 1;

FIG. 4 is a top view of the camera module in FIG. 1;

FIG. 5 is a side view of the camera module viewed along AA direction in FIG. 4;

FIG. 6 is a cross-sectional view of the camera module sectioned along B-B line in FIG. 4;

FIG. 7 is a side view of the camera module viewed along CC direction in FIG. 4;

FIG. 8 is a cross-sectional view of the camera module sectioned along D-D line in FIG. 7;

FIG. 9 is a schematic view showing the camera module in FIG. 8 that has been rotated with hatch lines being omitted;

FIG. 10 is an enlarged view of EE region of the camera module in FIG. 9;

FIG. 11 is an enlarged view of FF region of the camera module in FIG. 9;

FIG. 12 is a schematic view showing the position relationship between guiding tracks and balls of the camera module in FIG. 9;

FIG. 13 is a schematic view showing the position relationship between guiding tracks and balls of a camera module according to the 2nd embodiment of the present disclosure;

FIG. 14 is a perspective view of a camera module according to the 3rd embodiment of the present disclosure;

FIG. 15 is an exploded view of the camera module in FIG. 14;

FIG. 16 is another exploded view of the camera module in FIG. 14;

FIG. 17 is further another exploded view of the camera module in FIG. 14;

FIG. 18 is a top view of the camera module in FIG. 14;

FIG. 19 is a side view of the camera module viewed along GG direction in FIG. 18;

FIG. 20 is a cross-sectional view of the camera module sectioned along H-H line in FIG. 18;

FIG. 21 is a side view of the camera module viewed along II direction in FIG. 18;

FIG. 22 is a cross-sectional view of the camera module sectioned along J-J line in FIG. 21;

FIG. 23 is a schematic view showing the camera module in FIG. 22 that has been rotated with hatch lines being omitted;

FIG. 24 is an enlarged view of KK region of the camera module in FIG. 23;

FIG. 25 is an enlarged view of LL region of the camera module in FIG. 23;

FIG. 26 is a schematic view showing the position relationship between guiding tracks and balls of the camera module in FIG. 23;

FIG. 27 is a schematic view showing the position relationship between guiding tracks and balls of a camera module according to the 4th embodiment of the present disclosure;

FIG. 28 is a schematic view showing the position relationship between a base and a driving unit of a camera module according to the 5th embodiment of the present disclosure;

FIG. 29 is a schematic view showing the position relationship between a base and a driving unit of a camera module according to the 6th embodiment of the present disclosure;

FIG. 30 is a schematic view showing the position relationship between a base and a driving unit of a camera module according to the 7th embodiment of the present disclosure;

FIG. 31 is a perspective view of a camera module according to the 8th embodiment of the present disclosure;

FIG. 32 is an exploded view of the camera module in FIG. 31;

FIG. 33 is another exploded view of the camera module in FIG. 31;

FIG. 34 is a top view of the camera module in FIG. 31;

FIG. 35 is a side view of the camera module viewed along MM direction in FIG. 34;

FIG. 36 is a cross-sectional view of the camera module sectioned along N-N line in FIG. 35;

FIG. 37 is a side view of the camera module viewed along OO direction in FIG. 34;

FIG. 38 is a cross-sectional view of the camera module sectioned along P-P line in FIG. 34;

FIG. 39 is a schematic view showing the camera module in FIG. 38 that has been rotated with hatch lines being omitted;

FIG. 40 is an enlarged view of QQ region of the camera module in FIG. 39;

FIG. 41 is an enlarged view of RR region of the camera module in FIG. 39;

FIG. 42 is a schematic view showing the position relationship between guiding tracks and balls of the camera module in FIG. 39; FIG. 43 is a schematic view showing the position relationship between a base and balls of a camera module according to the 9th embodiment of the present disclosure;

FIG. 44 is a schematic view showing the position relationship between a base and balls of a camera module according to the 10th embodiment of the present disclosure;

FIG. 45 is a schematic view showing the position relationship between a base and balls of a camera module according to the 11th embodiment of the present disclosure;

FIG. 46 is a schematic view showing a side of an electronic device according to the 12th embodiment of the present disclosure; and

FIG. 47 is a schematic view showing another side of the electronic device in FIG. 46.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens driving module including an imaging lens, a lens carrier and a base. The imaging lens has an optical axis. The lens carrier mounts the imaging lens. The base is disposed corresponding to the lens carrier.

The lens carrier includes a first guiding track and a second guiding track. The base includes a third guiding track and a fourth guiding track.

The first guiding track extends along a direction parallel to the optical axis. The first guiding track has a first surface and a second surface that are connected to each other. The first surface is angled to the second surface. Moreover, the first surface can be angled to the second surface by a dihedral angle.

The second guiding track extends along a direction parallel to the optical axis. The second guiding track has a third surface and a fourth surface that are connected to each other. The third surface is angled to the fourth surface. Moreover, the third surface can be angled to the fourth surface by a dihedral angle.

The third guiding track extends along a direction parallel to the optical axis. The third guiding track has a fifth surface and a sixth surface that are connected to each other. The fifth surface is angled to the sixth surface. Moreover, the fifth surface can be angled to the sixth surface by a dihedral angle.

The fourth guiding track extends along a direction parallel to the optical axis. The fourth guiding track has a seventh surface and an eighth surface that are connected to each other. The seventh surface is angled to the eighth surface. Moreover, the seventh surface can be angled to the eighth surface by a dihedral angle.

The first guiding track is disposed corresponding to the third guiding track. Moreover, the corresponding configuration between the first guiding track and the third guiding track may be a shape correspondence between the “ [symbol] shape” and the “ [symbol] shape”, a shape correspondence between the “ [symbol] shape” and the “ [symbol] shape” or a shape correspondence between the “ [symbol] shape” and the “ [symbol] shape”. However, the present disclosure is not limited thereto.

The second guiding track is disposed corresponding to the fourth guiding track. Moreover, the corresponding configuration between the second guiding track and the fourth guiding track may be a shape correspondence between the “ [symbol] shape” and the “ [symbol] shape”, a shape correspondence between the “ [symbol] shape” and the “ [symbol] shape” or a shape correspondence between the “ [symbol] shape” and the “ [symbol] shape”. However, the present disclosure is not limited thereto.

Moreover, the “ [symbol] shape” for describing the guiding track may be considered that an angle between two surfaces of the said guiding track is an acute angle, the “ [symbol] shape” for describing the guiding track may be considered that an angle between two surfaces of the said guiding track is an obtuse angle, and the “ [symbol] shape” for describing the guiding track may be considered that an angle between two surfaces of the said guiding track is a right angle.

According to the present disclosure, the imaging lens driving module further includes a plurality of balls disposed between the lens carrier and the base. With the arrangement of the balls, it is favorable for providing degrees of freedom of translational movement of the lens carrier along a direction parallel to the optical axis with respect to the base.

The plurality of balls includes at least one first ball and at least one second ball. The at least one first ball is disposed between the first guiding track and the third guiding track. The at least one second ball is disposed between the second guiding track and the fourth guiding track.

Each of the first surface through the eighth surface is in physical contact with correspondingly disposed one among the plurality of balls through only one contact point. It can be also considered that one guiding track contacts one ball by two points. Therefore, it is favorable for ensuring the movement straightness of each ball along a direction parallel to the optical axis. However, the present disclosure is not limited thereto.

According to the present disclosure, the imaging lens driving module further includes a driving unit. The driving unit includes at least one magnet and at least one coil that are disposed corresponding to each other. One of the at least one magnet and the at least one coil is coupled to the lens carrier. In the case that the at least one magnet is coupled to the lens carrier, it can be considered as a movable-magnet driving configuration. In the case that the at least one coil is coupled to the lens carrier, it can be considered as a movable-coil driving configuration.

The driving unit is configured to move the lens carrier with respect to the base along a direction parallel to the optical axis. With the design of two contact points between each guiding track and one ball, it is favorable for enabling the movement of the lens carrier driven by the driving unit along each guiding track with respect to the base.

According to the imaging lens driving module of the present disclosure discussed above, by appropriately arranging the contact points between each of the first surface through the eighth surface and the balls, it is favorable for achieving a radial force balance along a direction perpendicular to the optical axis, which facilitating an alignment function between the lens carrier and the base. Also, through each guiding track, it is favorable for ensuring stability of the imaging lens during the auto-focus movement process, thereby improving image quality.

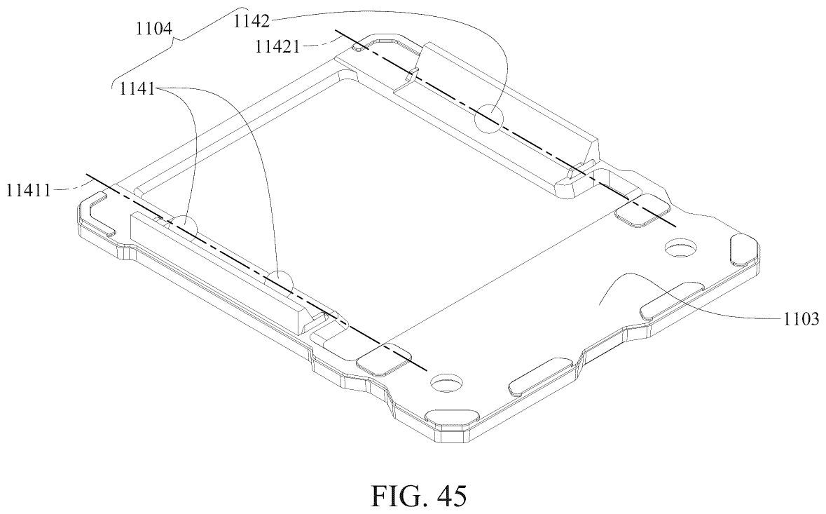

Further, the quantity of the at least one first ball can be at least two. By arranging the appropriate number of the first ball, it is favorable for improving the stability of the imaging lens during the auto-focus movement process. Further, the quantity of the at least one second ball can be at least two. By arranging the appropriate number of the second ball, it is favorable for improving the stability of the imaging lens during the auto-focus movement process. Alternatively, the quantity of the at least one second ball may be only one. By arranging the appropriate number of the second ball, it is favorable for optimizing the driving efficiency of the imaging lens driving module. Please refer to FIG. 45, which is a schematic view showing one second ball 1142 according to the 11th embodiment of the present disclosure.

In the case that the quantity of the first balls is at least two, the third guiding track of the base may further have a stopper. The at least two first balls disposed corresponding to the third guiding track are spaced apart from each other by the stopper of the third guiding track. Therefore, it is favorable for restricting the first balls within ideal supporting positions so as to prevent uneven supporting forces on the lens carrier caused by offset of the first balls from the original setting supporting positions, thereby improving the stability of the imaging lens during the auto-focus movement process. Please refer to FIG. 43, which is a schematic view showing the stopper 9313 of the third guiding track 931 according to the 9th embodiment of the present disclosure.

In the case that the quantity of the second balls is at least two, the fourth guiding track of the base may further have a stopper. The at least two second balls disposed corresponding to the fourth guiding track are space apart from each other by the stopper of the fourth guiding track. Therefore, it is favorable for restricting the second balls within ideal supporting positions so as to prevent uneven supporting forces on the lens carrier caused by offset of the second balls from the original setting supporting positions, thereby improving the stability of the imaging lens during the auto-focus movement process. Please refer to FIG. 43, which is a schematic view showing the stopper 9323 of the fourth guiding track 932 according to the 9th embodiment of the present disclosure.

Furthermore, the at least one first ball may have a first ball axis. The first ball axis may be formed by an axial movement path of the center of the at least one first ball along a direction parallel to the first guiding track. It can be also considered that the first ball axis may be a connection line of centers of any two or more first balls located on the same guiding track when the quantity of the first balls is at least two. With the arrangement of the first ball axis, it is favorable for maintaining the movement straightness of the lens carrier in high precision when driven by the driving unit.

Furthermore, the at least one second ball may have a second ball axis. The second ball axis may be formed by an axial movement path of the center of the at least one second ball along a direction parallel to the second guiding track. It can be also considered that the second ball axis may be a connection line of centers of any two or more second balls located on the same guiding track when the quantity of the second balls is at least two. With the arrangement of the second ball axis, it is favorable for maintaining the movement straightness of the lens carrier in high precision when driven by the driving unit.

Moreover, the first ball axis, the second ball axis and the optical axis may intersect a plane perpendicular to the optical axis at a first intersection point, a second intersection point and a third intersection point, respectively. A first line can be defined from the first intersection point to the second intersection point, a second line can be defined from the first intersection point to the third intersection point, and a third line can be defined from the second intersection point to the third intersection point. A first direction located on the plane can be defined as being parallel to the first line, and a second direction located on the plane is defined as being orthogonal to the first direction.

Moreover, a height of each of the first guiding track through the fourth guiding track along the first direction can be greater than a height of each of the at least one first ball through the at least one second ball along the first direction. Please be noted that since the height of each guiding track along the first direction can be greater than the height of each ball along the first direction, the observation of each ball along the second direction would be blocked by the corresponding guiding track, hindering any visual inspection of each ball along the second direction.

Moreover, a height of each of the first guiding track through the fourth guiding track along the second direction can be greater than a height of each of the at least one first ball through the at least one second ball along the second direction. Please be noted that since the height of each guiding track along the second direction can be greater than the height of each ball along the second direction, the observation of each ball along the first direction would be blocked by the corresponding guiding track, hindering any visual inspection of each ball along the first direction.

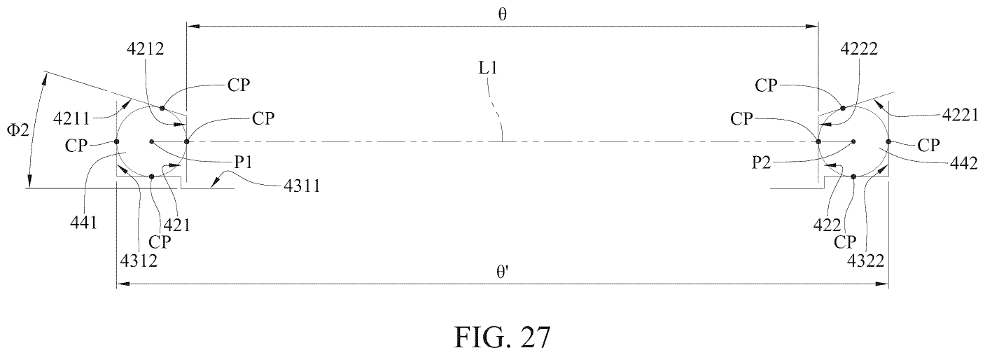

In some embodiments of the present disclosure, the first surface may be angled to the fifth surface. Therefore, it is favorable for increasing design margin of the guiding tracks so as to meet different driving requirements. Please refer to FIG. 27, which is a schematic view showing the angle Φ2 between the first surface 4211 and the fifth surface 4311 according to the 4th embodiment of the present disclosure.

In some embodiments of the present disclosure, the second surface may be angled to the sixth surface. Therefore, it is favorable for increasing design margin of the guiding tracks so as to meet different driving requirements. Please refer to FIG. 13, which is a schematic view showing the angle Φ1 between the second surface 2212 and the sixth surface 2312 according to the 2nd embodiment of the present disclosure.

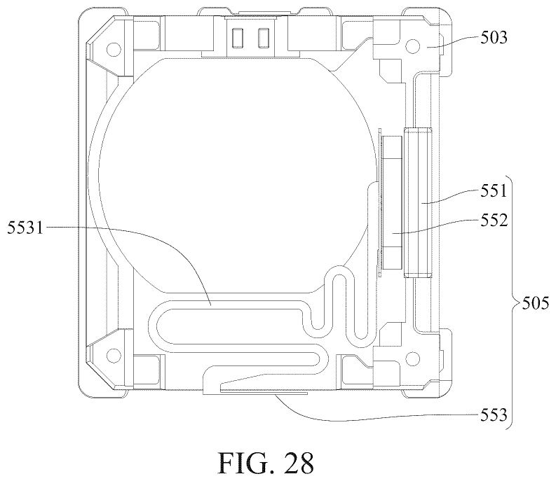

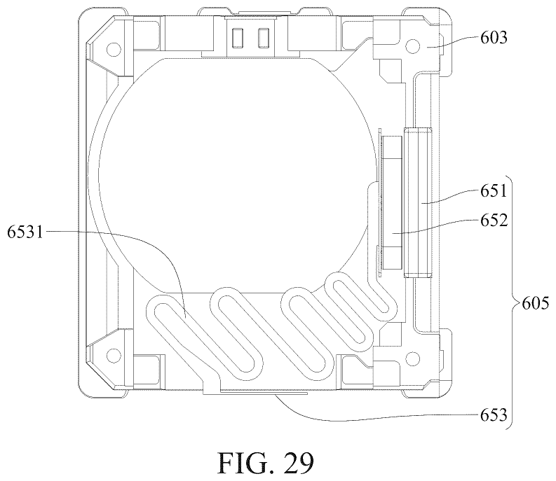

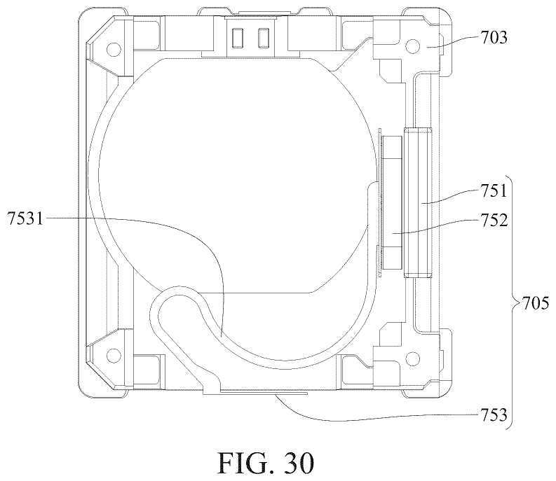

In some embodiments of the present disclosure, the driving unit may further include a flexible printed circuit (FPC). The at least one coil can be disposed on the flexible printed circuit. Therefore, through the bendable characteristic of the flexible printed circuit, it is favorable for achieving size compactness of the imaging lens driving module. Moreover, the flexible printed circuit can be coupled to the lens carrier. Therefore, it is favorable for ensuring the coil to be disposed in an ideal driving position, thereby increasing design margin of overall mechanism. Moreover, the wire of the flexible printed circuit can be designed with appropriate routing, so that the flexible printed circuit can possess elastic tolerance in a direction parallel to the optical axis when moved along with the lens carrier. This design aims to prevent any potential damage or breakage of the wire of the flexible printed circuit. Please refer to FIG. 28. FIG. 29 and FIG. 30, which are schematic views showing different designs of the wires 5531, 6531, 7531 according to the 5th, 6th and 7th embodiments of the present disclosure, respectively.

When an angle between the second surface and the fourth surface is θ, the following condition can be satisfied: 0°≤θ<130°.

When an angle between the sixth surface and the eighth surface is θ′, the following condition can be satisfied: 0°≤θ′<130°.

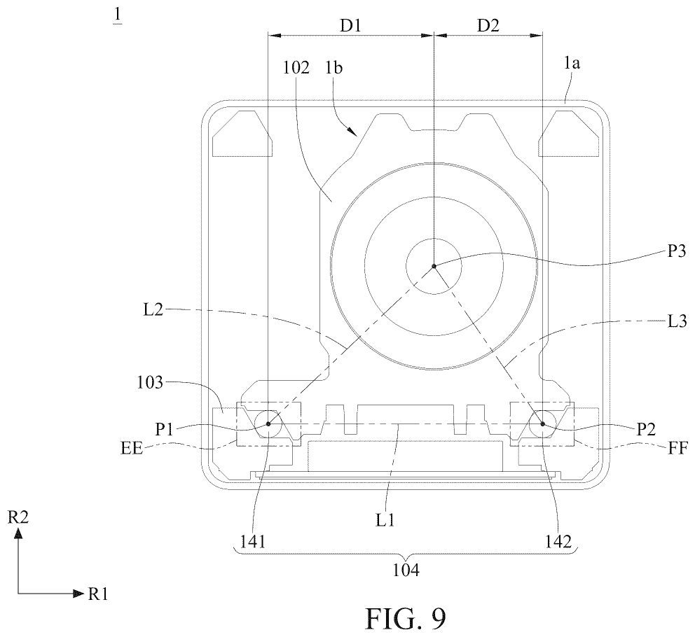

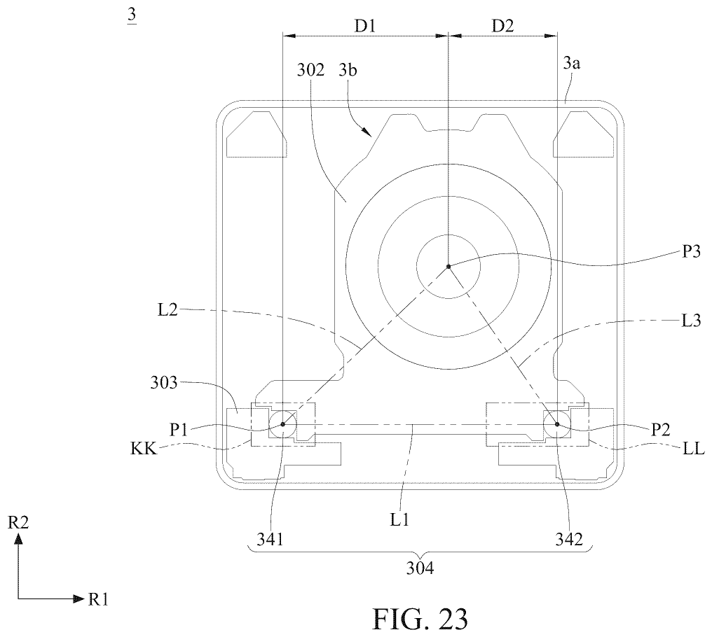

When a distance of the second line projected onto the first line is D1, and a distance of the third line projected onto the first line is D2, the following condition can be satisfied: 1.05≤D1/D2<6. Therefore, it can be known that the optical axis of the imaging lens is offset to one end of the first line from the central point thereof, rather than corresponding to the central point of the first line. This configuration is favorable for effectively utilizing the remaining corner space to improving space utilization, thereby further meeting the strict spatial limitations within a mobile phone during the assembly of a camera module with the imaging lens driving module into the mobile phone. Please refer to FIG. 9 and FIG. 23, which are schematic views showing D1 and D2 according to the 1st and 3rd embodiments of the present disclosure.

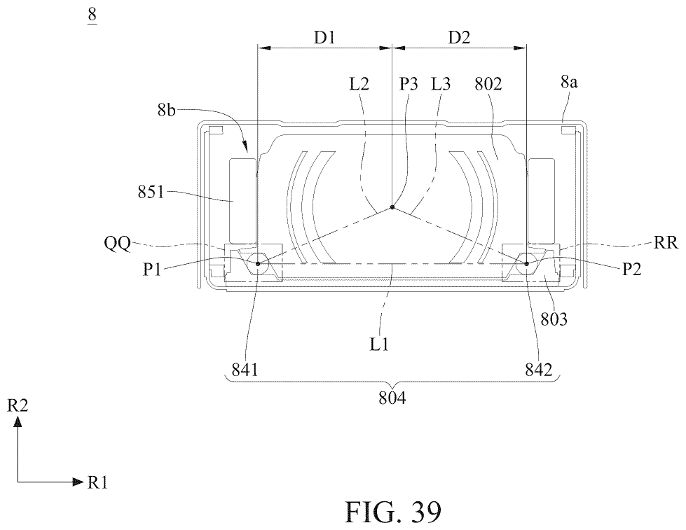

When the distance of the second line projected onto the first line is D1, and the distance of the third line projected onto the first line is D2, the following condition can be satisfied: D1=D2. Therefore, it can be known that the optical axis of the imaging lens corresponds to the central point of the first line. Please refer to FIG. 39, which is a schematic view showing D1 and D2 of the 8th embodiment of the present disclosure.

The present disclosure provides a camera module that includes the abovementioned imaging lens driving module.

The present disclosure provides an electronic device that includes the abovementioned camera module and an image sensor disposed on an image surface of the camera module.

According to the present disclosure, the aforementioned features and conditions can be utilized in numerous combinations so as to achieve corresponding effects.

According to the above description of the present disclosure, the following specific embodiments are provided for further explanation.

### 1st Embodiment

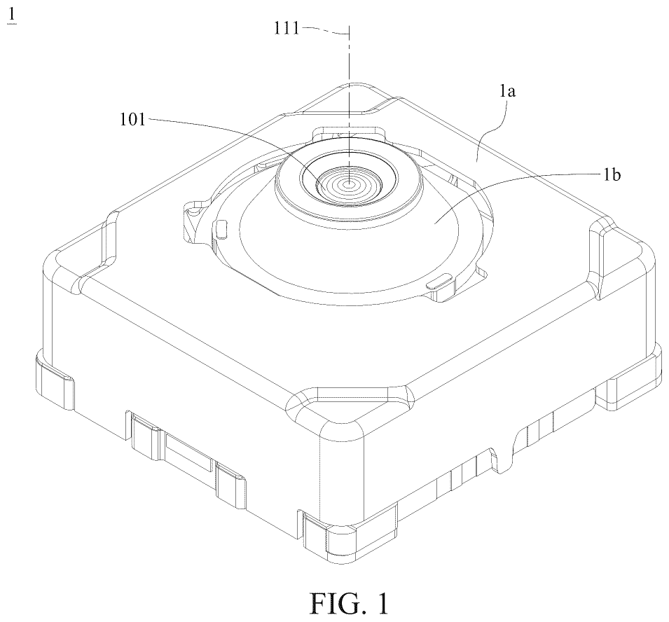

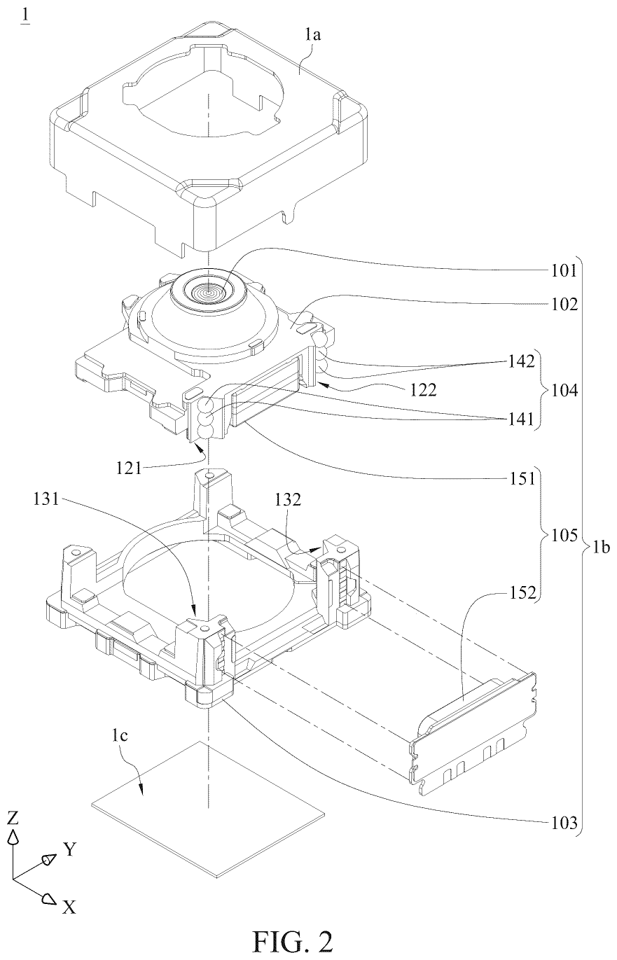

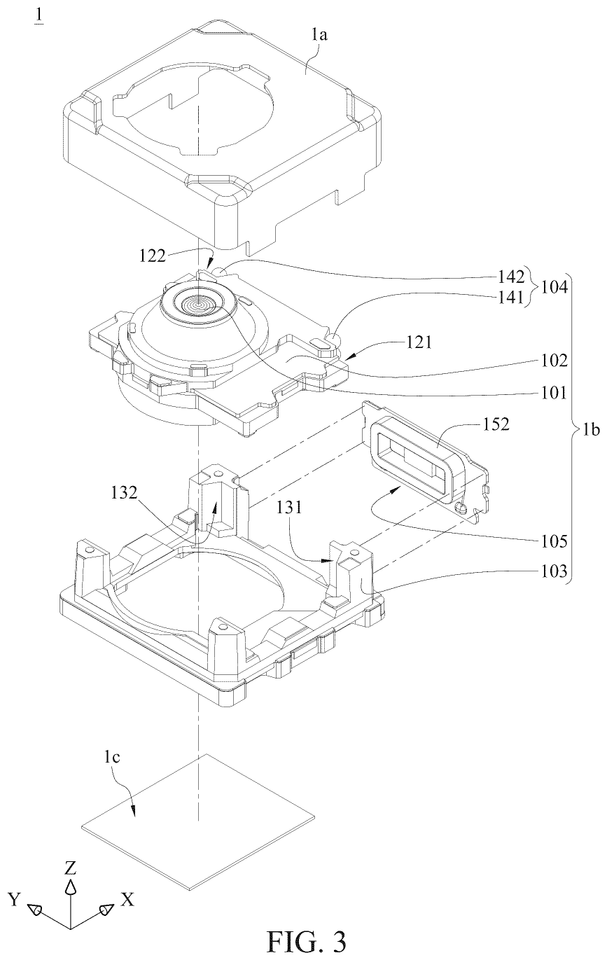

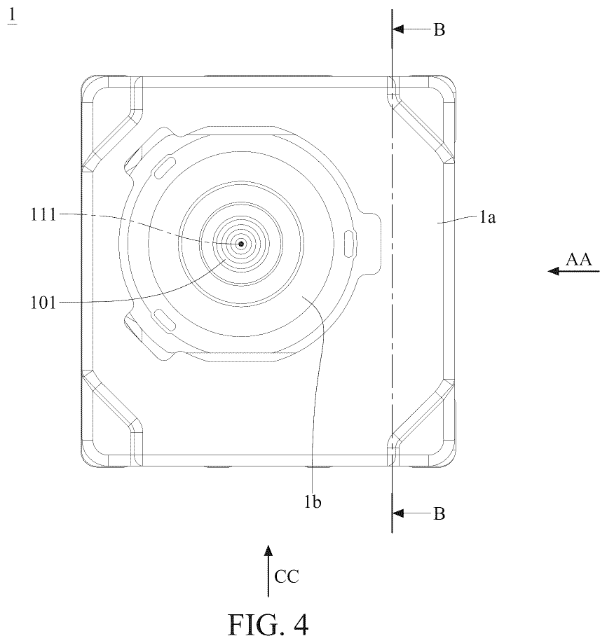

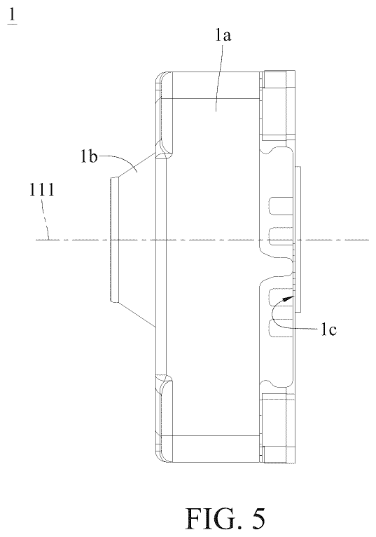

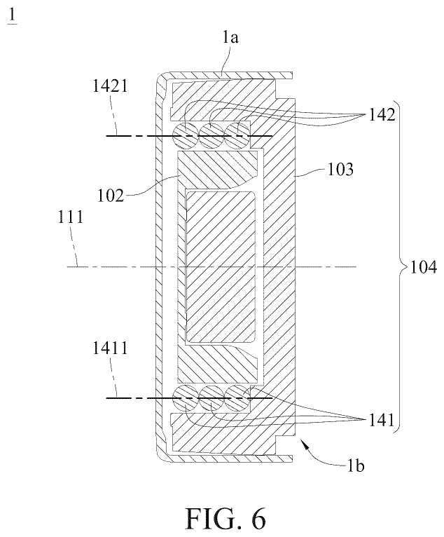

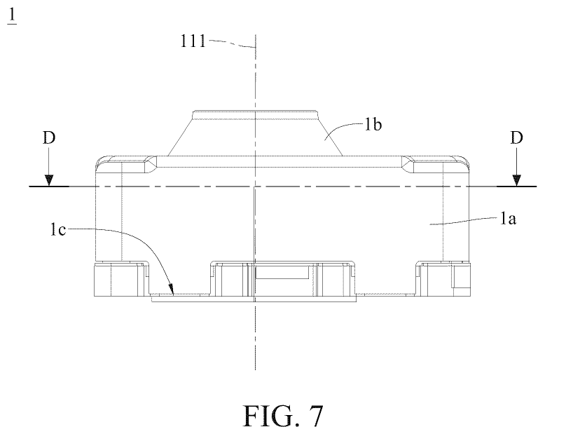

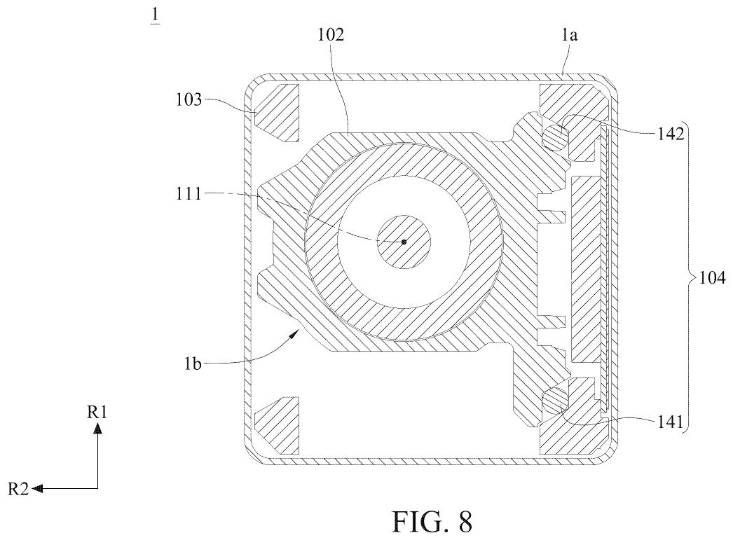

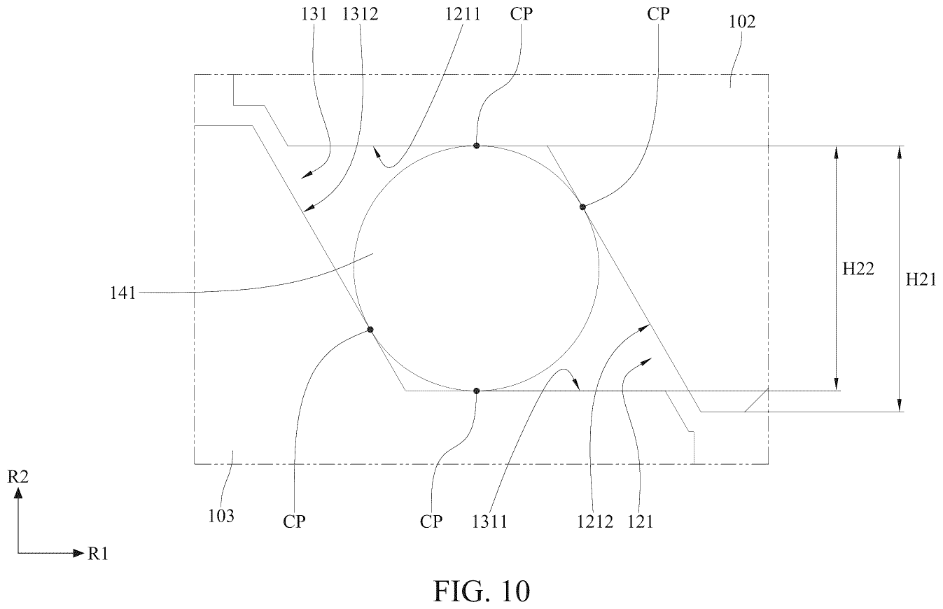

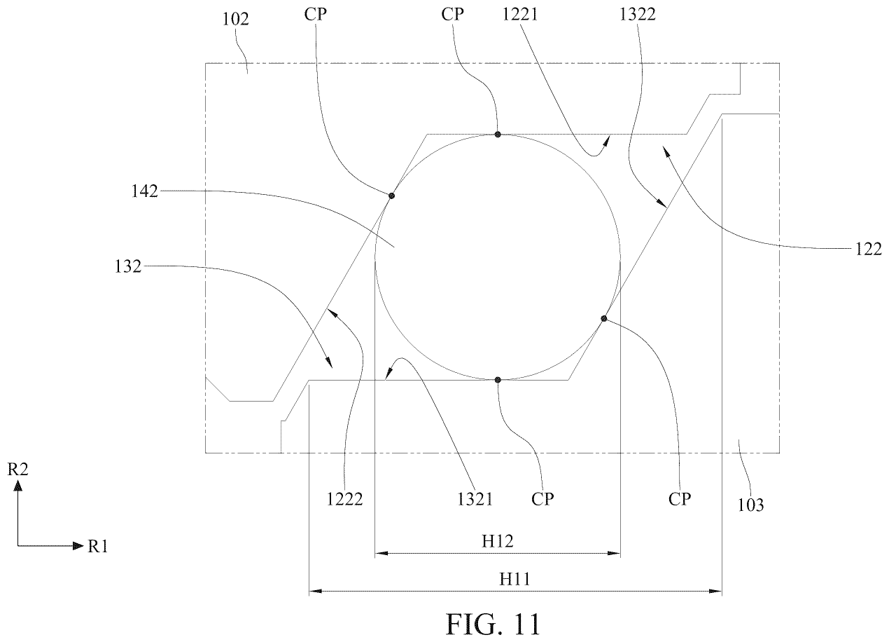

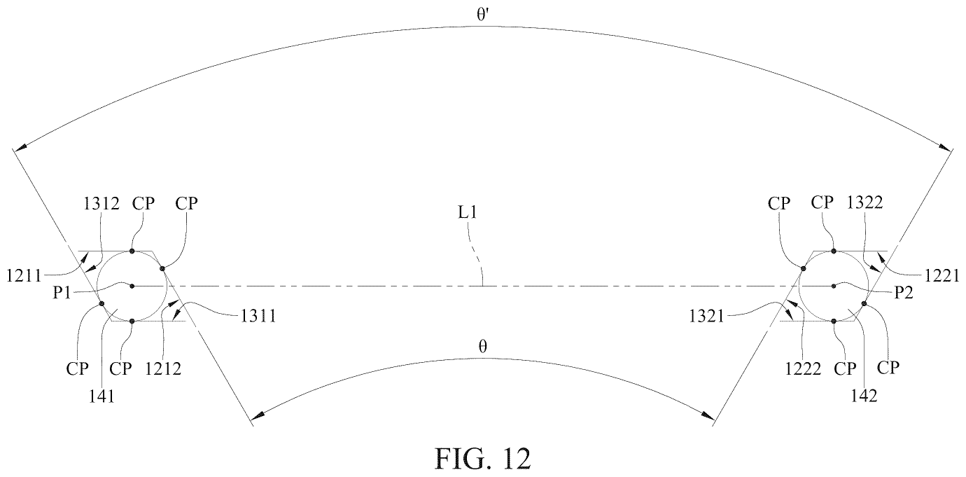

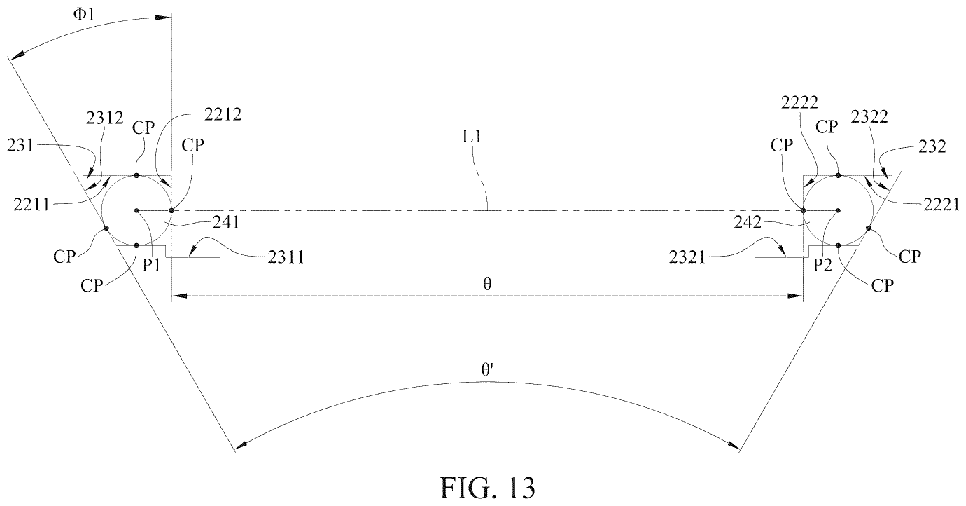

Please refer to FIG. 1 to FIG. 12, where FIG. 1 is a perspective view of a camera module according to the 1st embodiment of the present disclosure, FIG. 2 is an exploded view of the camera module in FIG. 1, FIG. 3 is another exploded view of the camera module in FIG. 1, FIG. 4 is a top view of the camera module in FIG. 1, FIG. 5 is a side view of the camera module viewed along AA direction in FIG. 4, FIG. 6 is a cross-sectional view of the camera module sectioned along B-B line in FIG. 4, FIG. 7 is a side view of the camera module viewed along CC direction in FIG. 4, FIG. 8 is a cross-sectional view of the camera module sectioned along D-D line in FIG. 7, FIG. 9 is a schematic view showing the camera module in FIG. 8 that has been rotated with hatch lines being omitted, FIG. 10 is an enlarged view of EE region of the camera module in FIG. 9, FIG. 11 is an enlarged view of FF region of the camera module in FIG. 9, and FIG. 12 is a schematic view showing the position relationship between guiding tracks and balls of the camera module in FIG. 9.

A camera module 1 provided in this embodiment includes a casing 1a, an imaging lens driving module 1b and an image surface 1c. The imaging lens driving module 1b is disposed in the casing 1a. Light passing through the imaging lens driving module 1b images on the image surface 1c where an image sensor (not numbered) is disposed for transferring an electrical signal converted from an optical signal.

The imaging lens driving module 1b includes an imaging lens 101, a lens carrier 102, a base 103, a plurality of balls 104 and a driving unit 105.

The imaging lens 101 has an optical axis 111 passing through the image surface 1c. The lens carrier 102 mounts the imaging lens 101. The base 103 is disposed corresponding to the lens carrier 102.

The lens carrier 102 includes a first guiding track 121 and a second guiding track 122. The base 103 includes a third guiding track 131 and a fourth guiding track 132.

The first guiding track 121 extends along a direction parallel to the optical axis 111. The first guiding track 121 has a first surface 1211 and a second surface 1212, as shown in FIG. 10. The first surface 1211 and the second surface 1212 are connected to each other and are angled to each other by a dihedral angle.

The second guiding track 122 extends along a direction parallel to the optical axis 111. The second guiding track 122 has a third surface 1221 and a fourth surface 1222, as shown in FIG. 11. The third surface 1221 and the fourth surface 1222 are connected to each other and are angled to each other by a dihedral angle.

The third guiding track 131 extends along a direction parallel to the optical axis 111. The third guiding track 131 has a fifth surface 1311 and a sixth surface 1312, as shown in FIG. 10. The fifth surface 1311 and the sixth surface 1312 are connected to each other and are angled to each other by a dihedral angle.

The fourth guiding track 132 extends along a direction parallel to the optical axis 111. The fourth guiding track 132 has a seventh surface 1321 and an eighth surface 1322, as shown in FIG. 11. The seventh surface 1321 and the eighth surface 1322 are connected to each other and are angled to each other by a dihedral angle.

The first guiding track 121 and the third guiding track 131 are arranged corresponding to each other by a shape correspondence as the “ [symbol] shape” to the “ [symbol] shape”. It can be also considered that the first surface 1211 is angled to the second surface 1212 by an obtuse angle, and the fifth surface 1311 is angled to the sixth surface 1312 by an obtuse angle.

The second guiding track 122 and the fourth guiding track 132 are arranged corresponding to each other by a shape correspondence as the “ [symbol] shape” to the “ [symbol] shape”. It can be also considered that the seventh surface 1321 is angled to the eighth surface 1322 by an obtuse angle, and the third surface 1221 is angled to the fourth surface 1222 by an obtuse angle.

The balls 104 are disposed between the lens carrier 102 and the base 103 for providing degrees of freedom of translational movement of the lens carrier 102 along a direction parallel to the optical axis 111 with respect to the base 103. The balls 104 include three first balls 141 and three second balls 142. The first balls 141 are disposed between the first guiding track 121 and the third guiding track 131. The second balls 142 are disposed between the second guiding track 122 and the fourth guiding track 132.

The first balls 141 have a first ball axis 1411. The first ball axis 1411 is formed by an axial movement path of the center of the first balls 141 along a direction parallel to the first guiding track 121. It can be also considered that the first ball axis 1411 is a connection line of centers of any two or more first balls 141, as shown in FIG. 6.

The second balls 142 have a second ball axis 1421. The second ball axis 1421 is formed by an axial movement path of the center of the second balls 142 along a direction parallel to the second guiding track 122. It can be also considered that the second ball axis 1421 is a connection line of centers of any two or more second balls 142, as shown in FIG. 6.

The first ball axis 1411, the second ball axis 1421 and the optical axis 111 intersect a plane perpendicular to the optical axis 111 at a first intersection point P1, a second intersection point P2 and a third intersection point P3, respectively. As shown in FIG. 8 and FIG. 9, FIG. 8 is the cross-sectional view of the camera module 1 sectioned along the D-D line in FIG. 7 in which the surface formed by the section along the D-D line is precisely the abovementioned plane perpendicular to the optical axis 111, and the first ball axis 1411, the second ball axis 1421 and the optical axis 111 intersect the abovementioned plane to respectively form the first intersection point P1, the second intersection point P2 and the third intersection point P3 in FIG. 9.

A first line L1 is defined from the first intersection point P1 to the second intersection point P2, a second line L2 is defined from the first intersection point P1 to the third intersection point P3, and a third line L3 is defined from the second intersection point P2 to the third intersection point P3, as shown in FIG. 9. A first direction R1 located on the abovementioned plane is defined as being parallel to the first line L1, and a second direction R2 located on the abovementioned plane is defined as being orthogonal to the first direction R1.

A height of each of the first guiding track 121 through the fourth guiding track 132 along the first direction R1 is greater than a height of each of the first balls 141 through the second balls 142 along the first direction R1. For example, as shown in FIG. 11, a height H11 of the fourth guiding track 132 along the first direction R1 is greater than a height H12 of single second ball 142 along the first direction R1.

A height of each of the first guiding track 121 through the fourth guiding track 132 along the second direction R2 is greater than a height of each of the first balls 141 through the second balls 142 along the second direction R2. For example, as shown in FIG. 10, a height H21 of the first guiding track 121 along the second direction R2 is greater than a height H22 of single first ball 141 along the second direction R2.

Each of the first surface 1211 through the eighth surface 1322 is in physical contact with correspondingly disposed one among the balls 104 through only one contact point. As shown in FIG. 10, the first surface 1211 is in physical contact with a correspondingly disposed first ball 141 through only one contact point CP, the second surface 1212 is in physical contact with a correspondingly disposed first ball 141 through only one contact point CP, the fifth surface 1311 is in physical contact with a correspondingly disposed first ball 141 through only one contact point CP, and the sixth surface 1312 is in physical contact with a correspondingly disposed first ball 141 through only one contact point CP. As shown in FIG. 11, the third surface 1221 is in physical contact with a correspondingly disposed second ball 142 through only one contact point CP, the fourth surface 1222 is in physical contact with a correspondingly disposed second ball 142 through only one contact point CP, the seventh surface 1321 is in physical contact with a correspondingly disposed second ball 142 through only one contact point CP, and the eighth surface 1322 is in physical contact with a correspondingly disposed second ball 142 through only one contact point CP. It can be also considered that the first guiding track 121 contacts single first ball 141 by two points, the second guiding track 122 contacts single second ball 142 by two points, the third guiding track 131 contacts single first ball 141 by two points, and the fourth guiding track 132 contacts single second ball 142 by two points.

The driving unit 105 includes a magnet 151 and a coil 152. The magnet 151 is coupled to the lens carrier 102. The coil 152 is disposed corresponding to the magnet 151.

The magnet 151 and the lens carrier 102 together form a movable-magnet driving configuration, such that the driving unit 105 is able to stably move the lens carrier 102 with respect to the base 103 along all of the first guiding track 121 through the fourth guiding track 132 in a direction parallel to the optical axis 111. Moreover, the position configuration of each contact point CP assists in achieving a radial force balance along a direction perpendicular to the optical axis 111, such that the lens carrier 102 and the base 103 have an alignment function to each other.

When an angle between the second surface 1212 and the fourth surface 1222 is θ, the following condition is satisfied: θ=60°, wherein θ is shown as in FIG. 12.

When an angle between the sixth surface 1312 and the eighth surface 1322 is θ′, the following condition is satisfied: θ′=60°, wherein θ′ is shown as in FIG. 12.

When a distance of the second line L2 projected onto the first line L1 is D1, and a distance of the third line L3 projected onto the first line L1 is D2, the following conditions are satisfied: D1=3.6 mm (millimeters); D2=2.4 mm; and D1/D2=1.5, wherein D1 and D2 are shown as in FIG. 9.

### 2nd Embodiment

A camera module (not numbered) provided in this embodiment is similar to the camera module 1 provided in the previous embodiment, and therefore only difference between this and the previous embodiments, as well as necessary description, will be illustrated hereinafter.

Please refer to FIG. 13, which is a schematic view showing the position relationship between guiding tracks and balls of a camera module according to the 2nd embodiment of the present disclosure.

In this embodiment, the third guiding track 231 has a step difference at the fifth surface 2311, and the fourth guiding track 232 has a step difference at the seventh surface 2321. However, the third guiding track 231 still contacts single first ball 241 through two contact points CP, and the fourth guiding track 232 still contacts single second ball 242 through two contact points CP.

In detail, the first surface 2211 is in physical contact with a correspondingly disposed first ball 241 through only one contact point CP, the second surface 2212 is in physical contact with a correspondingly disposed first ball 241 through only one contact point CP, the third surface 2221 is in physical contact with a correspondingly disposed second ball 242 through only one contact point CP, the fourth surface 2222 is in physical contact with a correspondingly disposed second ball 242 through only one contact point CP, the sixth surface 2312 is in physical contact with a correspondingly disposed first ball 241 through only one contact point CP, and the eighth surface 2322 is in physical contact with a correspondingly disposed second ball 242 through only one contact point CP.

In this embodiment, the second surface 2212 is angled to the sixth surface 2312 by an angle Φ1.

When an angle between the second surface 2212 and the fourth surface 2222 is θ, the following condition is satisfied: θ=0°.

When an angle between the sixth surface 2312 and the eighth surface 2322 is θ′, the following condition is satisfied: θ′=60°.

### 3rd Embodiment

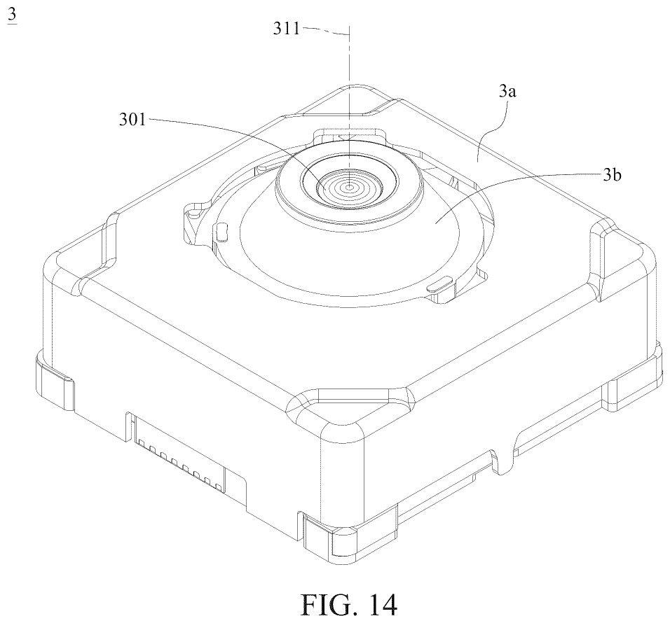

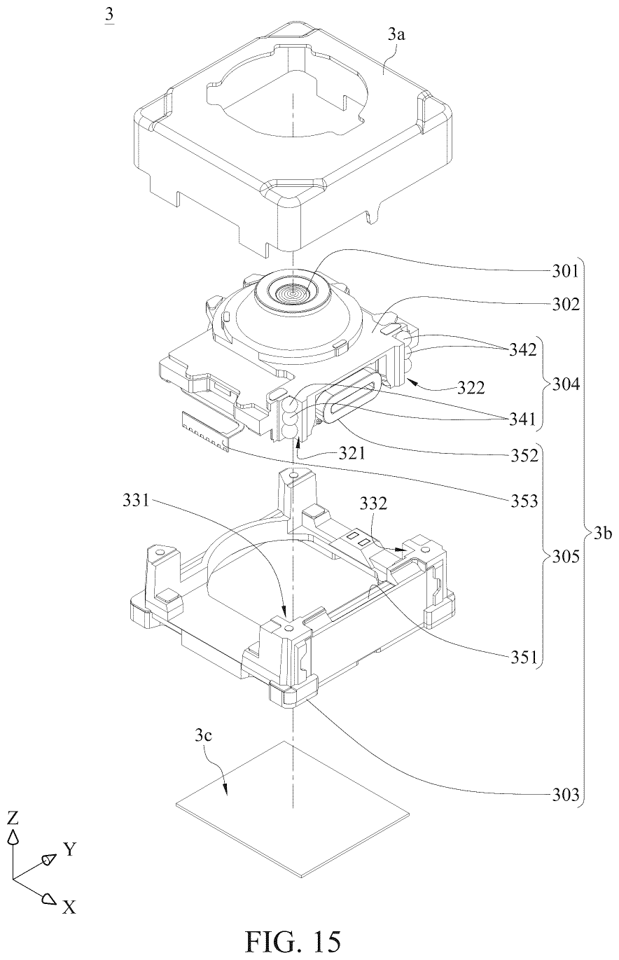

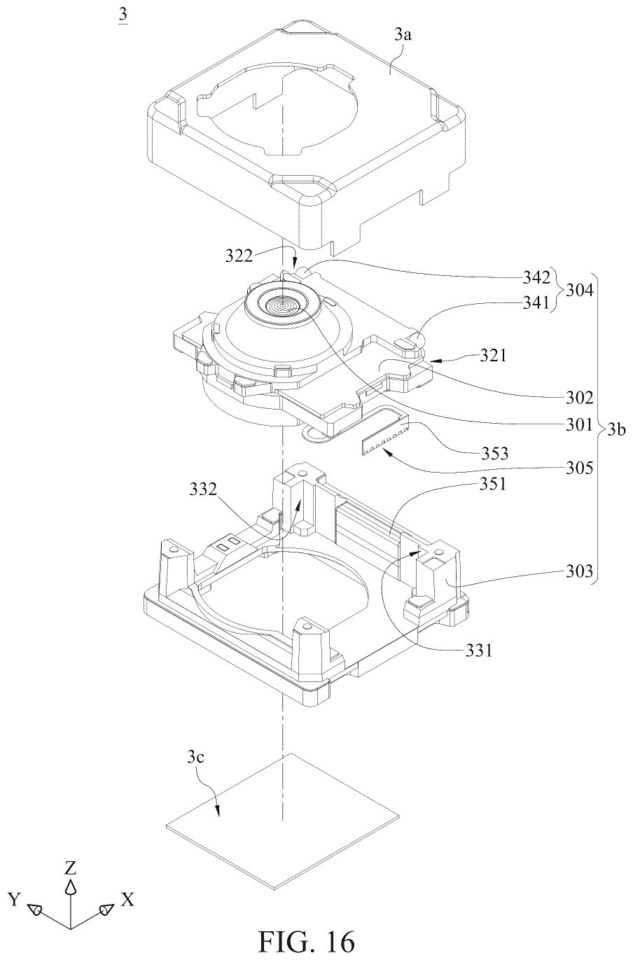

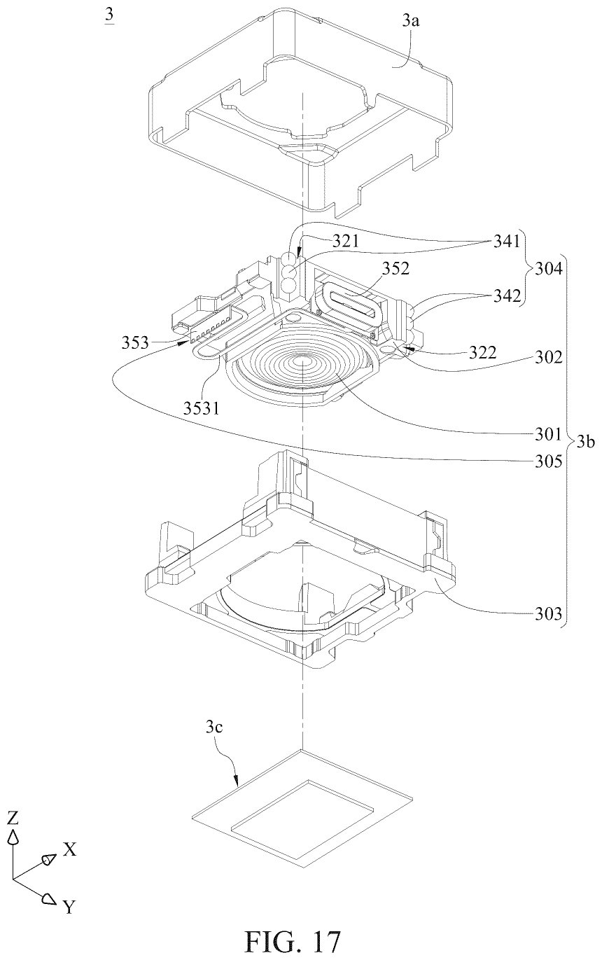

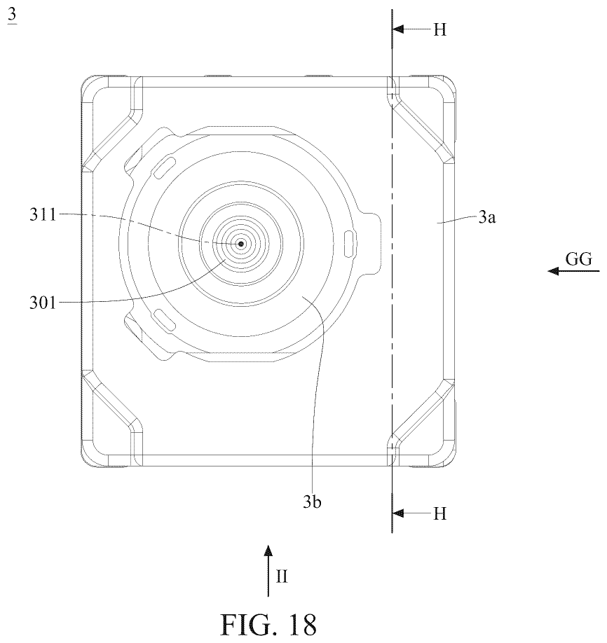

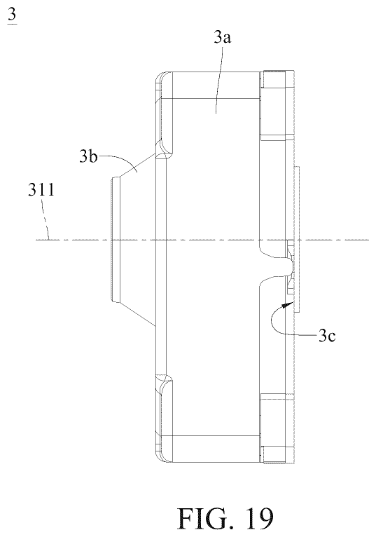

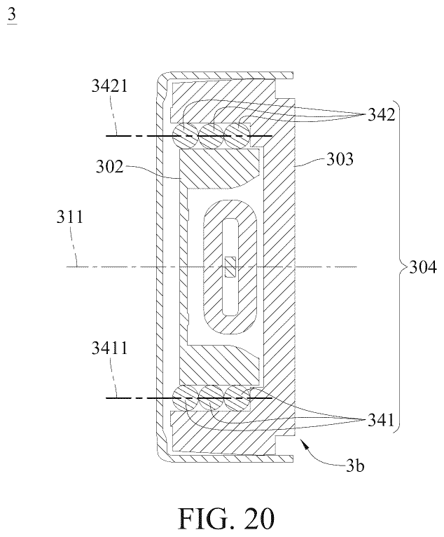

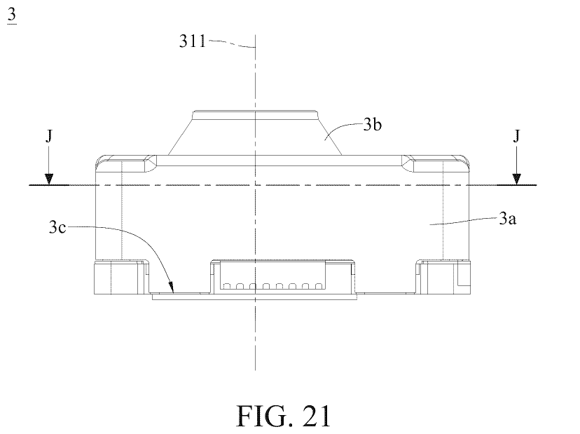

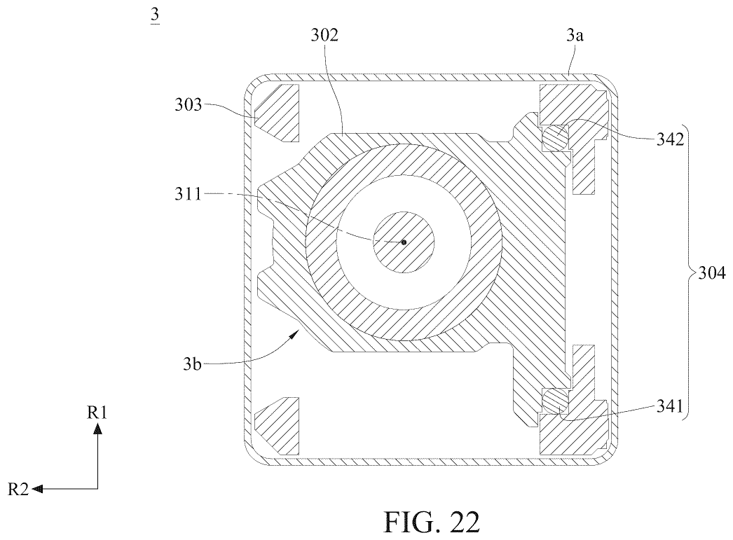

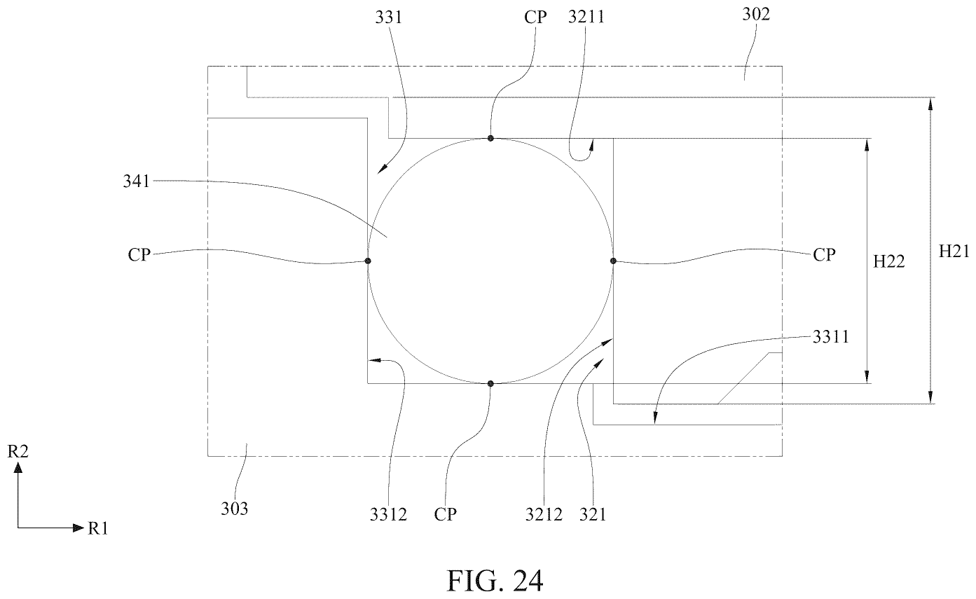

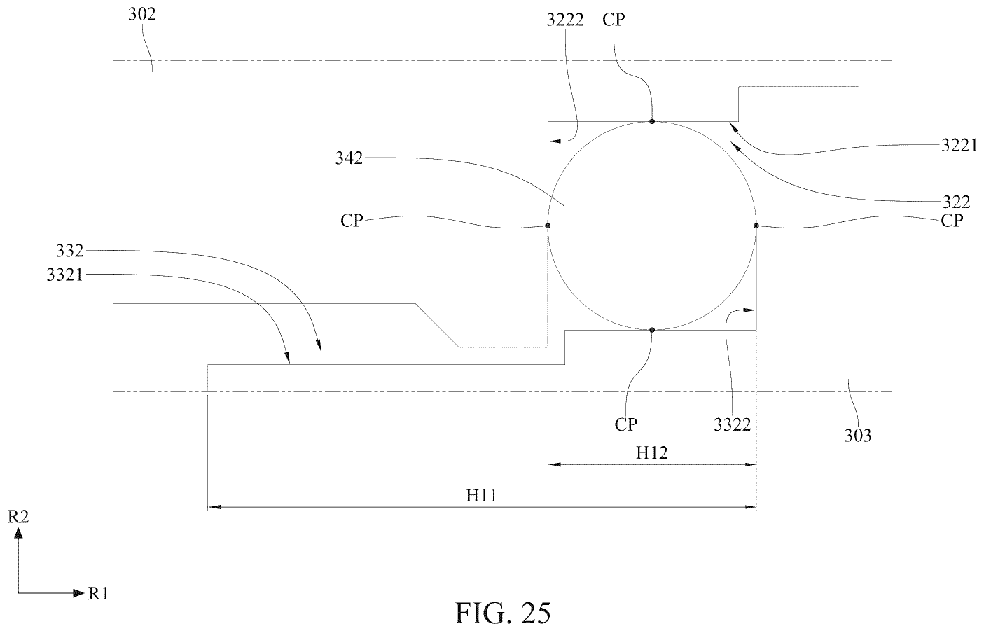

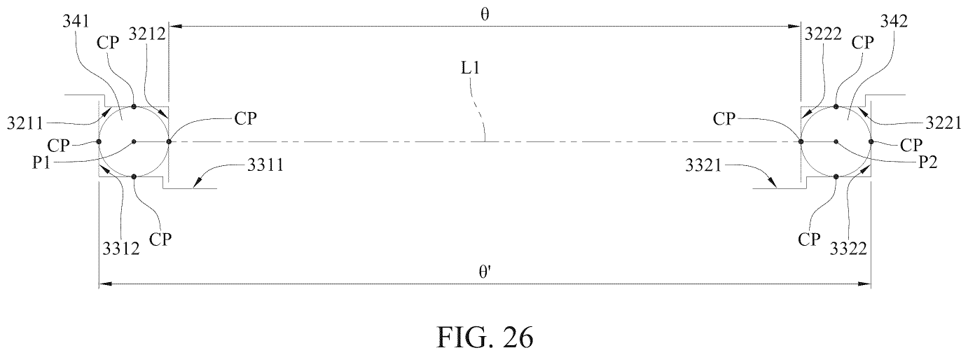

Please refer to FIG. 14 to FIG. 26, where FIG. 14 is a perspective view of a camera module according to the 3rd embodiment of the present disclosure, FIG. 15 is an exploded view of the camera module in FIG. 14, FIG. 16 is another exploded view of the camera module in FIG. 14, FIG. 17 is further another exploded view of the camera module in FIG. 14, FIG. 18 is a top view of the camera module in FIG. 14, FIG. 19 is a side view of the camera module viewed along GG direction in FIG. 18, FIG. 20 is a cross-sectional view of the camera module sectioned along H-H line in FIG. 18, FIG. 21 is a side view of the camera module viewed along II direction in FIG. 18, FIG. 22 is a cross-sectional view of the camera module sectioned along J-J line in FIG. 21, FIG. 23 is a schematic view showing the camera module in FIG. 22 that has been rotated with hatch lines being omitted, FIG. 24 is an enlarged view of KK region of the camera module in FIG. 23, FIG. 25 is an enlarged view of LL region of the camera module in FIG. 23, and FIG. 26 is a schematic view showing the position relationship between guiding tracks and balls of the camera module in FIG. 23.

A camera module 3 provided in this embodiment includes a casing 3a, an imaging lens driving module 3b and an image surface 3c. The imaging lens driving module 3b is disposed in the casing 3a. Light passing through the imaging lens driving module 3b images on the image surface 3c where an image sensor (not numbered) is disposed for transferring an electrical signal converted from an optical signal.

The imaging lens driving module 3b includes an imaging lens 301, a lens carrier 302, a base 303, a plurality of balls 304 and a driving unit 305.

The imaging lens 301 has an optical axis 311 passing through the image surface 3c. The lens carrier 302 mounts the imaging lens 301. The base 303 is disposed corresponding to the lens carrier 302.

The lens carrier 302 includes a first guiding track 321 and a second guiding track 322. The base 303 includes a third guiding track 331 and a fourth guiding track 332.

The first guiding track 321 extends along a direction parallel to the optical axis 311. The first guiding track 321 has a first surface 3211 and a second surface 3212, as shown in FIG. 24. The first surface 3211 and the second surface 3212 are connected to each other and are angled to each other by a dihedral angle.

The second guiding track 322 extends along a direction parallel to the optical axis 311. The second guiding track 322 has a third surface 3221 and a fourth surface 3222, as shown in FIG. 25. The third surface 3221 and the fourth surface 3222 are connected to each other and are angled to each other by a dihedral angle.

The third guiding track 331 extends along a direction parallel to the optical axis 311. The third guiding track 331 has a fifth surface 3311 and a sixth surface 3312, as shown in FIG. 24. The fifth surface 3311 and the sixth surface 3312 are connected to each other and are angled to each other.

The fourth guiding track 332 extends along a direction parallel to the optical axis 311. The fourth guiding track 332 has a seventh surface 3321 and an eighth surface 3322, as shown in FIG. 25. The seventh surface 3321 and the eighth surface 3322 are connected to each other and are angled to each other.

The first guiding track 321 and the third guiding track 331 are arranged corresponding to each other by a shape correspondence as the “L shape” to the “L shape”. It can be also considered that the first surface 3211 is angled to the second surface 3212 by a right angle, and the fifth surface 3311 is angled to the sixth surface 3312 by a right angle.

The second guiding track 322 and the fourth guiding track 332 are arranged corresponding to each other by a shape correspondence as the “L shape” to the “L shape”. It can be also considered that the seventh surface 3321 is angled to the eighth surface 3322 by a right angle, and the third surface 3221 is angled to the fourth surface 3222 by a right angle.

The balls 304 are disposed between the lens carrier 302 and the base 303 for providing degrees of freedom of translational movement of the lens carrier 302 along a direction parallel to the optical axis 311 with respect to the base 303. The balls 304 include three first balls 341 and three second balls 342. The first balls 341 are disposed between the first guiding track 321 and the third guiding track 331. The second balls 342 are disposed between the second guiding track 322 and the fourth guiding track 332.

The first balls 341 have a first ball axis 3411. The first ball axis 3411 is formed by an axial movement path of the center of the first balls 341 along a direction parallel to the first guiding track 321. It can be also considered that the first ball axis 3411 is a connection line of centers of any two or more first balls 341, as shown in FIG. 20.

The second balls 342 have a second ball axis 3421. The second ball axis 3421 is formed by an axial movement path of the center of the second balls 342 along a direction parallel to the second guiding track 322. It can be also considered that the second ball axis 3421 is a connection line of centers of any two or more second balls 342, as shown in FIG. 20.

The first ball axis 3411, the second ball axis 3421 and the optical axis 311 intersect a plane perpendicular to the optical axis 311 at a first intersection point P1, a second intersection point P2 and a third intersection point P3, respectively. As shown in FIG. 22 and FIG. 23, FIG. 22 is the cross-sectional view of the camera module 3 sectioned along the J-J line in FIG. 21 in which the surface formed by the section along the J-J line is precisely the abovementioned plane perpendicular to the optical axis 311, and the first ball axis 3411, the second ball axis 3421 and the optical axis 311 intersect the abovementioned plane to respectively form the first intersection point P1, the second intersection point P2 and the third intersection point P3 in FIG. 23.

A first line L1 is defined from the first intersection point P1 to the second intersection point P2, a second line L2 is defined from the first intersection point P1 to the third intersection point P3, and a third line L3 is defined from the second intersection point P2 to the third intersection point P3, as shown in FIG. 23. A first direction R1 located on the abovementioned plane is defined as being parallel to the first line L1, and a second direction R2 located on the abovementioned plane is defined as being orthogonal to the first direction R1.

A height of each of the first guiding track 321 through the fourth guiding track 332 along the first direction R1 is greater than a height of each of the first balls 341 through the second balls 342 along the first direction R1. For example, as shown in FIG. 25, a height H11 of the fourth guiding track 332 along the first direction R1 is greater than a height H12 of single second ball 342 along the first direction R1.

A height of each of the first guiding track 321 through the fourth guiding track 332 along the second direction R2 is greater than a height of each of the first balls 341 through the second balls 342 along the second direction R2. For example, as shown in FIG. 24, a height H21 of the first guiding track 321 along the second direction R2 is greater than a height H22 of single first ball 341 along the second direction R2.

In this embodiment, the first guiding track 321 has a step difference at the first surface 3211, the second guiding track 322 has a step difference at the third surface 3221, the third guiding track 331 has a step difference at the fifth surface 3311, and the fourth guiding track 332 has a step difference at the seventh surface 3321. However, the first guiding track 321 still contacts single first ball 341 through two contact points CP, the second guiding track 322 still contacts single second ball 342 through two contact points CP, the third guiding track 331 still contacts single first ball 341 through two contact points CP, and the fourth guiding track 332 still contacts single second ball 342 through two contact points CP.

In detail, as shown in FIG. 24, the first surface 3211 is in physical contact with a correspondingly disposed first ball 341 through only one contact point CP, the second surface 3212 is in physical contact with a correspondingly disposed first ball 341 through only one contact point CP, and the sixth surface 3312 is in physical contact with a correspondingly disposed first ball 341 through only one contact point CP. As shown in FIG. 25, the third surface 3221 is in physical contact with a correspondingly disposed second ball 342 through only one contact point CP, the fourth surface 3222 is in physical contact with a correspondingly disposed second ball 342 through only one contact point CP, and the eighth surface 3322 is in physical contact with a correspondingly disposed second ball 342 through only one contact point CP.

The driving unit 305 includes a magnet 351, a coil 352 and a flexible printed circuit 353. The coil 352 is disposed on the flexible printed circuit 353 and coupled to the lens carrier 302. The coil 352 is disposed corresponding to the magnet 351. Moreover, the flexible printed circuit 353 is also coupled to the lens carrier 302.

The coil 352 and the lens carrier 302 together form a movable-coil driving configuration, such that the driving unit 305 is able to stably move the lens carrier 302 with respect to the base 303 along all of the first guiding track 321 through the fourth guiding track 332 in a direction parallel to the optical axis 311. Moreover, the position configuration of each contact point CP assists in achieving a radial force balance along a direction perpendicular to the optical axis 311, such that the lens carrier 302 and the base 303 have an alignment function to each other.

The flexible printed circuit 353 has a wire 3531. The wire 3531 is designed in routing to be folded in at least one direction perpendicular to the optical axis 311, so that the flexible printed circuit 353 possess elastic tolerance in a direction parallel to the optical axis 311 when the flexible printed circuit 353 is moved along with the lens carrier 302. This design aims to prevent any potential damage or breakage of the wire 3531 of the flexible printed circuit 353.

When an angle between the second surface 3212 and the fourth surface 3222 is θ, the following condition is satisfied: θ=0°, wherein θ is shown as in FIG. 26.

When an angle between the sixth surface 3312 and the eighth surface 3322 is θ′, the following condition is satisfied: θ′=0°, wherein θ′ is shown as in FIG. 26.

When a distance of the second line L2 projected onto the first line L1 is D1, and a distance of the third line L3 projected onto the first line L1 is D2, the following conditions are satisfied: D1=3.6 mm; D2=2.4 mm; and D1/D2=1.5, wherein D1 and D2 are shown as in FIG. 23.

### 4th Embodiment

A camera module (not numbered) provided in this embodiment is similar to the camera module 3 provided in the previous embodiment, and therefore only difference between this and the previous embodiments, as well as necessary description, will be illustrated hereinafter.

Please refer to FIG. 27, which is a schematic view showing the position relationship between guiding tracks and balls of a camera module according to the 4th embodiment of the present disclosure.

In this embodiment, the first guiding track 421 has no step difference at the first surface 4211, and the second guiding track 422 has no step difference at the third surface 4221. However, the first guiding track 421 still contacts single first ball 441 through two contact points CP, and the second guiding track 422 still contacts single second ball 442 through two contact points CP.

In detail, the first surface 4211 is in physical contact with a correspondingly disposed first ball 441 through only one contact point CP, the second surface 4212 is in physical contact with a correspondingly disposed first ball 441 through only one contact point CP, the third surface 4221 is in physical contact with a correspondingly disposed second ball 442 through only one contact point CP, the fourth surface 4222 is in physical contact with a correspondingly disposed second ball 442 through only one contact point CP, the sixth surface 4312 is in physical contact with a correspondingly disposed first ball 441 through only one contact point CP, and the eighth surface 4322 is in physical contact with a correspondingly disposed second ball 442 through only one contact point CP.

In this embodiment, the first surface 4211 is angled to the fifth surface 4311 by an angle Φ2.

When an angle between the second surface 4212 and the fourth surface 4222 is θ, the following condition is satisfied: θ=0°.

When an angle between the sixth surface 4312 and the eighth surface 4322 is θ′, the following condition is satisfied: θ′=0°.

### 5th Embodiment

A camera module (not numbered) provided in this embodiment is similar to the camera module 3 provided in the third embodiment, and therefore only difference between this and the third embodiments, as well as necessary description, will be illustrated hereinafter.

Please refer to FIG. 28, which is a schematic view showing the position relationship between a base and a driving unit of a camera module according to the 5th embodiment of the present disclosure. Please be noted that only the base 503 and the magnet 551, the coil 552 and the flexible printed circuit 553 of the driving unit 505 are depicted in FIG. 28 for clearly showing the wire 5531 of the flexible printed circuit 553.

In this embodiment, the wire 5531 is designed in routing to be folded in at least two directions perpendicular to each other, so that the flexible printed circuit 553 possess elastic tolerance during the auto-focus movement process of the camera module. This design aims to prevent any potential damage or breakage of the wire 5531 of the flexible printed circuit 553.

### 6th Embodiment

A camera module (not numbered) provided in this embodiment is similar to the camera module 3 provided in the third embodiment, and therefore only difference between this and the third embodiments, as well as necessary description, will be illustrated hereinafter.

Please refer to FIG. 29, which is a schematic view showing the position relationship between a base and a driving unit of a camera module according to the 6th embodiment of the present disclosure. Please be noted that only the base 603 and the magnet 651, the coil 652 and the flexible printed circuit 653 of the driving unit 605 are depicted in FIG. 29 for clearly showing the wire 6531 of the flexible printed circuit 653.

In this embodiment, the wire 6531 is designed in routing to be folded in at least one direction oblique with respect to a fixed end thereof, so that the flexible printed circuit 653 possess elastic tolerance during the auto-focus movement process of the camera module. This design aims to prevent any potential damage or breakage of the wire 6531 of the flexible printed circuit 653.

### 7th Embodiment

A camera module (not numbered) provided in this embodiment is similar to the camera module 3 provided in the third embodiment, and therefore only difference between this and the third embodiments, as well as necessary description, will be illustrated hereinafter.

Please refer to FIG. 30, which is a schematic view showing the position relationship between a base and a driving unit of a camera module according to the 7th embodiment of the present disclosure. Please be noted that only the base 703 and the magnet 751, the coil 752 and the flexible printed circuit 753 of the driving unit 705 are depicted in FIG. 30 for clearly showing the wire 7531 of the flexible printed circuit 753.

In this embodiment, the wire 7531 is designed in routing to be folded in at least one circumferential direction, so that the flexible printed circuit 753 possess elastic tolerance during the auto-focus movement process of the camera module. This design aims to prevent any potential damage or breakage of the wire 7531 of the flexible printed circuit 753.

### 8th Embodiment

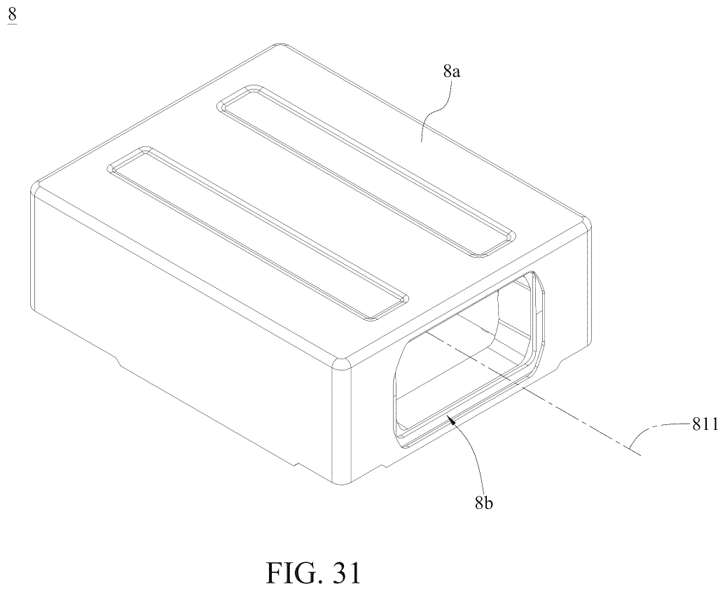

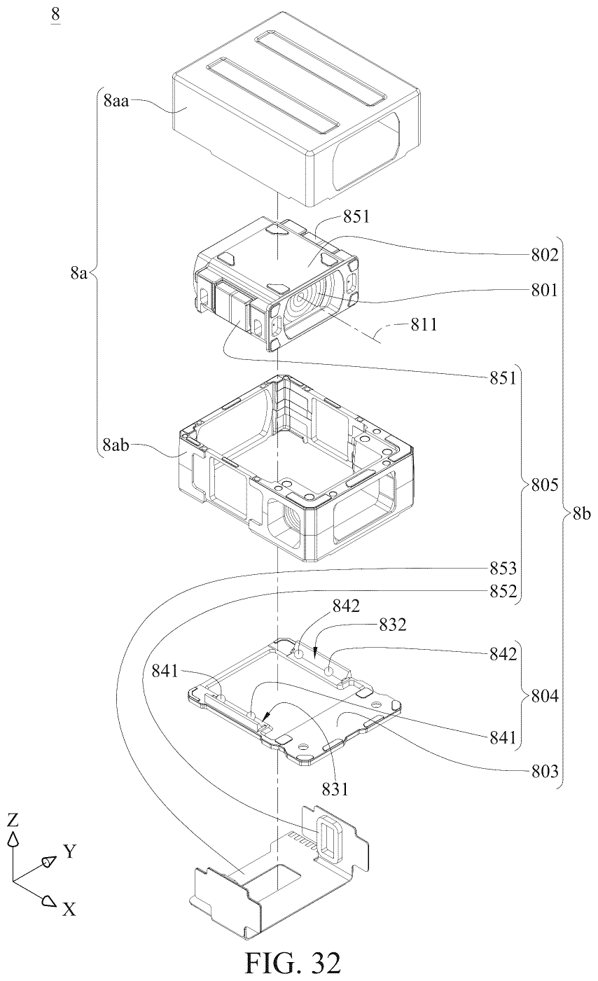

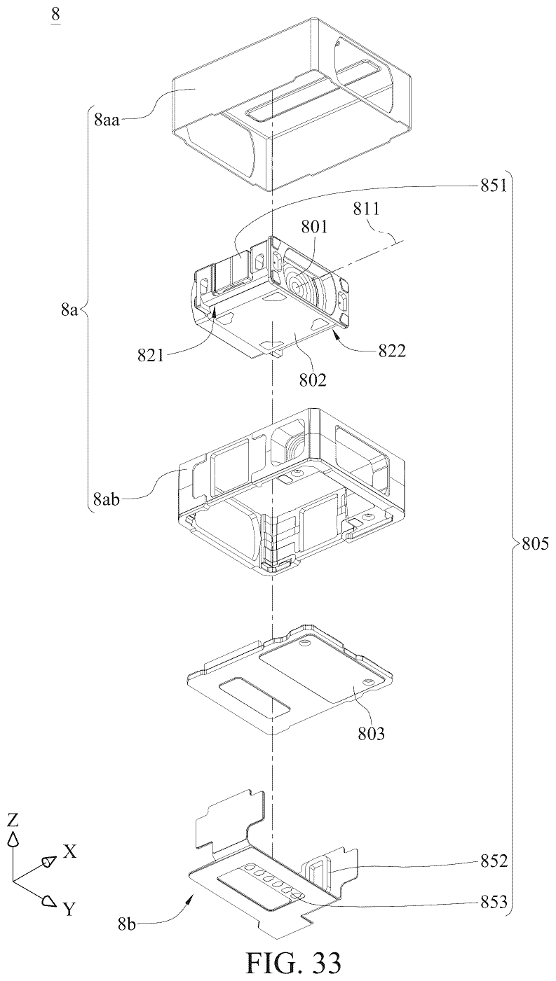

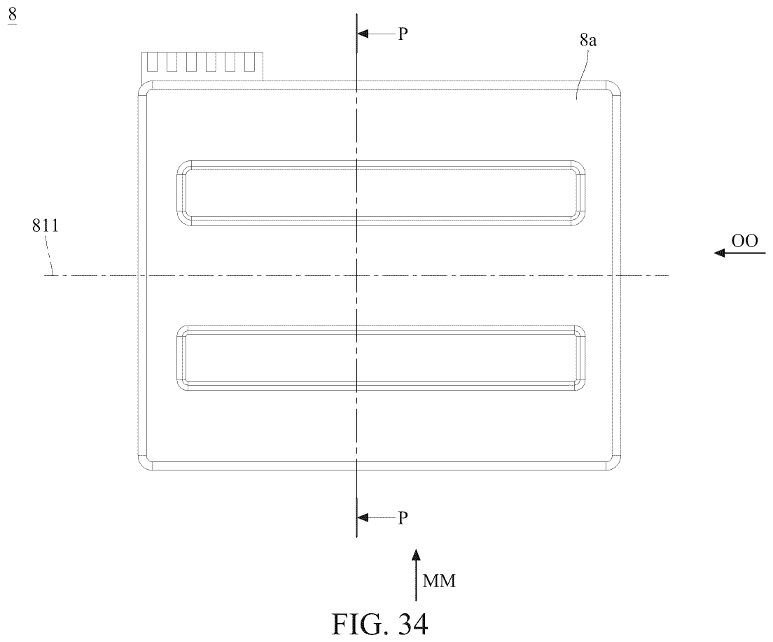

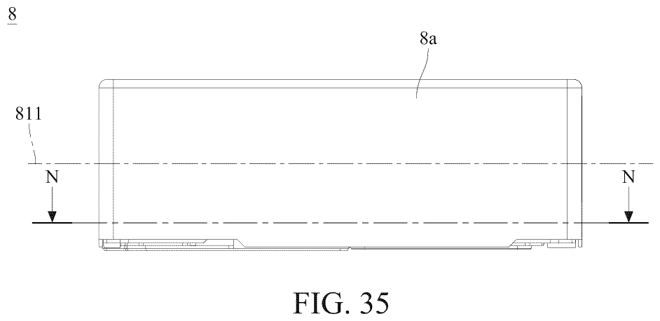

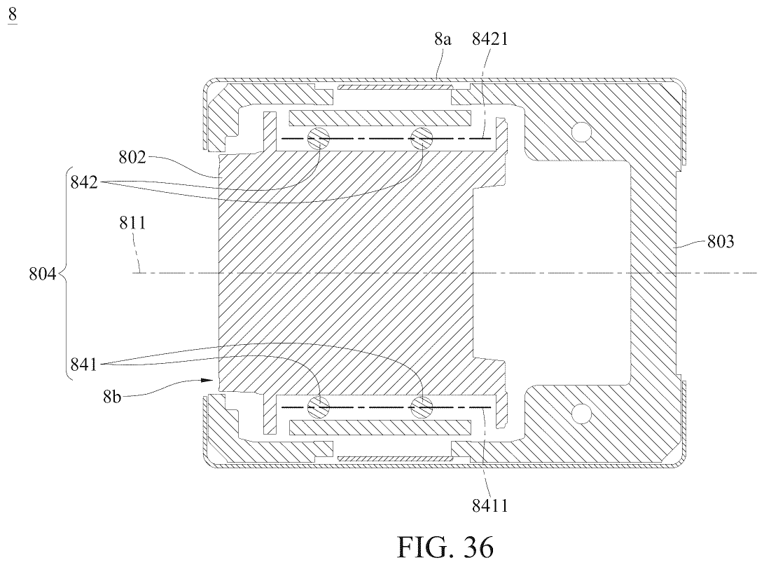

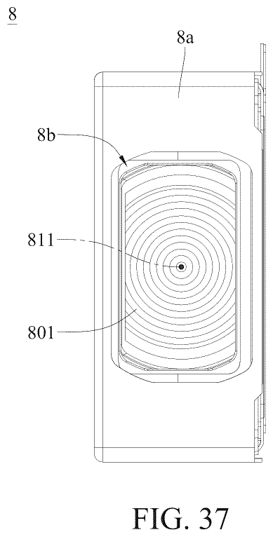

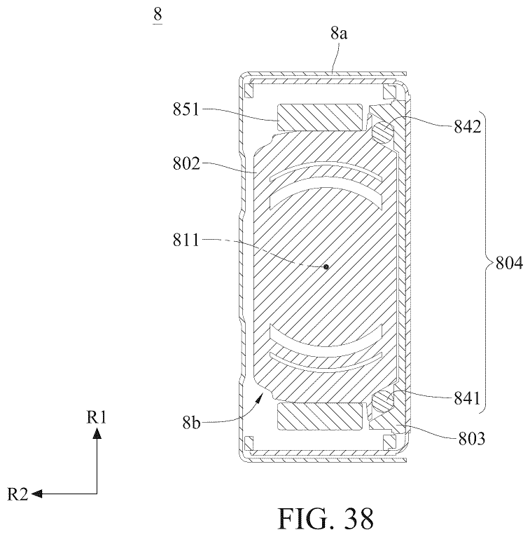

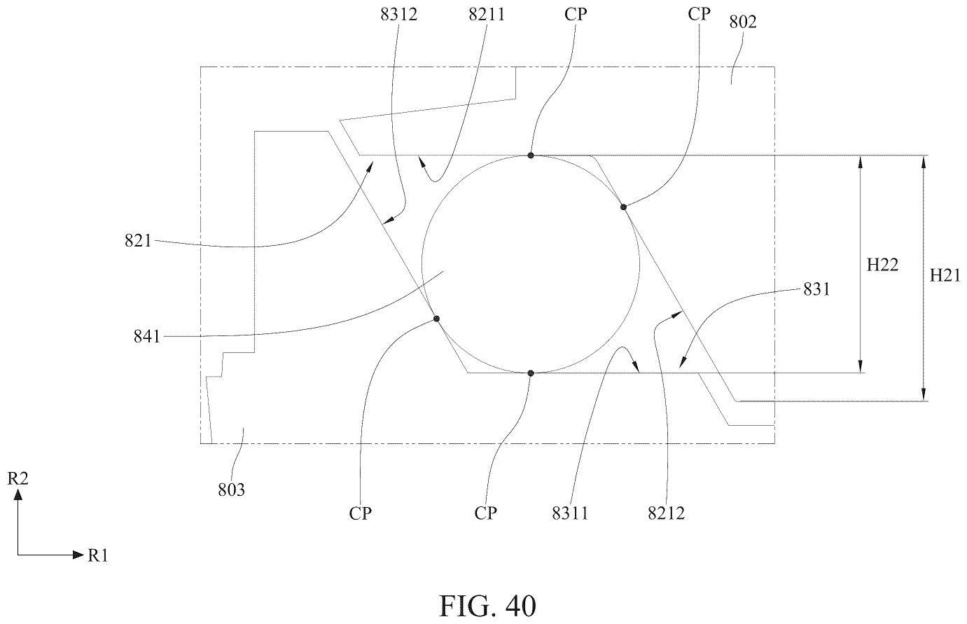

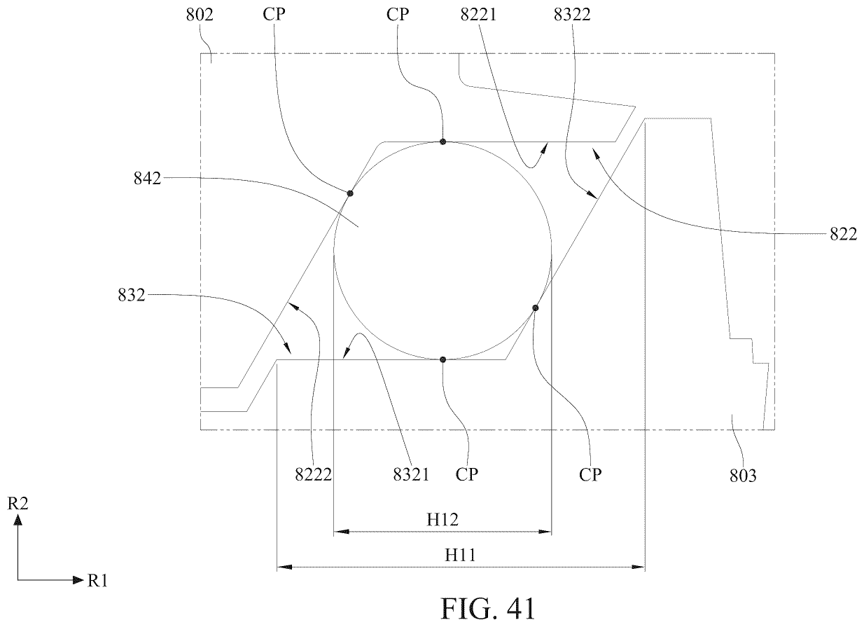

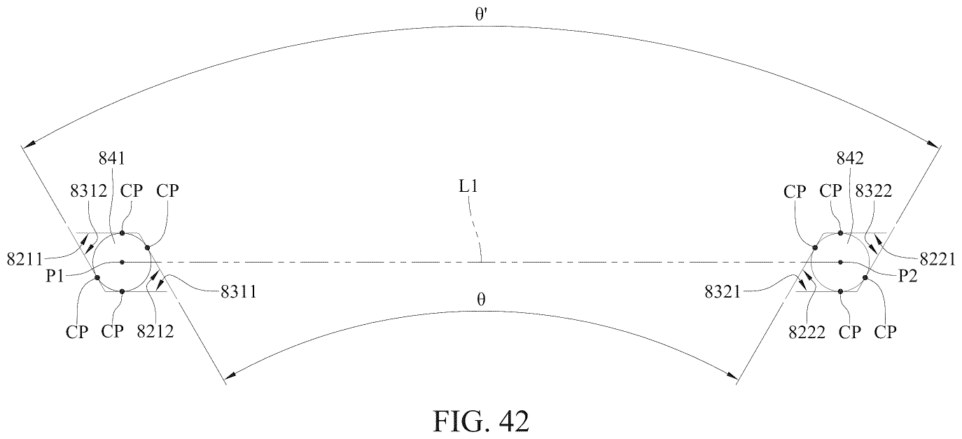

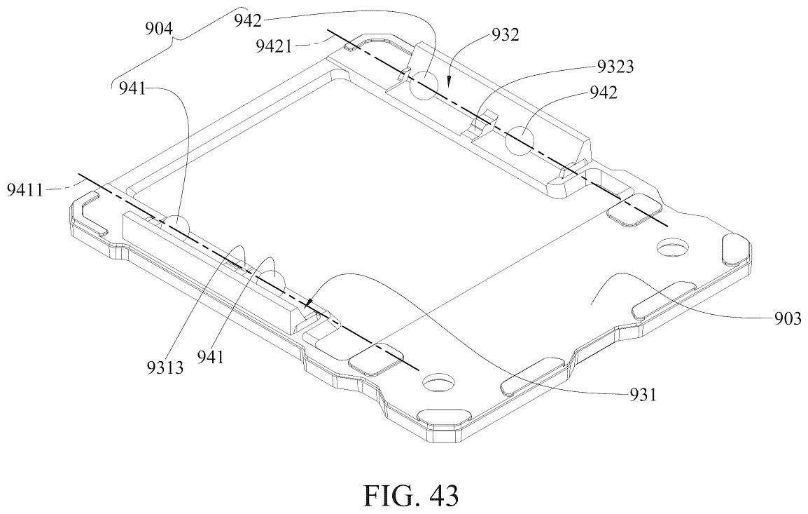

Please refer to FIG. 31 to FIG. 42, where FIG. 31 is a perspective view of a camera module according to the 8th embodiment of the present disclosure, FIG. 32 is an exploded view of the camera module in FIG. 31, FIG. 33 is another exploded view of the camera module in FIG. 31, FIG. 34 is a top view of the camera module in FIG. 31, FIG. 35 is a side view of the camera module viewed along MM direction in FIG. 34, FIG. 36 is a cross-sectional view of the camera module sectioned along N-N line in FIG. 35, FIG. 37 is a side view of the camera module viewed along OO direction in FIG. 34, FIG. 38 is a cross-sectional view of the camera module sectioned along P-P line in FIG. 34, FIG. 39 is a schematic view showing the camera module in FIG. 38 that has been rotated with hatch lines being omitted, FIG. 40 is an enlarged view of QQ region of the camera module in FIG. 39, FIG. 41 is an enlarged view of RR region of the camera module in FIG. 39, and FIG. 42 is a schematic view showing the position relationship between guiding tracks and balls of the camera module in FIG. 39.

A camera module 8 provided in this embodiment includes a casing 8a and an imaging lens driving module 8b. the casing 8a includes an upper casing 8aa and a lower casing 8ab. The imaging lens driving module 8b is disposed in the casing 8a. Light passes through the imaging lens driving module 8b for imaging, and there is an image sensor (not shown) configured for transferring an electrical signal converted from an optical signal of the imaging.

The imaging lens driving module 8b includes an imaging lens 801, a lens carrier 802, a base 803, a plurality of balls 804 and a driving unit 805.

The imaging lens 801 has an optical axis 811. The lens carrier 802 mounts the imaging lens 801. The base 803 is disposed corresponding to the lens carrier 802.

The lens carrier 802 includes a first guiding track 821 and a second guiding track 822. The base 803 includes a third guiding track 831 and a fourth guiding track 832.

The first guiding track 821 extends along a direction parallel to the optical axis 811. The first guiding track 821 has a first surface 8211 and a second surface 8212, as shown in FIG. 40. The first surface 8211 and the second surface 8212 are connected to each other and are angled to each other by a dihedral angle.

The second guiding track 822 extends along a direction parallel to the optical axis 811. The second guiding track 822 has a third surface 8221 and a fourth surface 8222, as shown in FIG. 41. The third surface 8221 and the fourth surface 8222 are connected to each other and are angled to each other by a dihedral angle.

The third guiding track 831 extends along a direction parallel to the optical axis 811. The third guiding track 831 has a fifth surface 8311 and a sixth surface 8312, as shown in FIG. 40. The fifth surface 8311 and the sixth surface 8312 are connected to each other and are angled to each other by a dihedral angle.

The fourth guiding track 832 extends along a direction parallel to the optical axis 811. The fourth guiding track 832 has a seventh surface 8321 and an eighth surface 8322, as shown in FIG. 41. The seventh surface 8321 and the eighth surface 8322 are connected to each other and are angled to each other by a dihedral angle.

The first guiding track 821 and the third guiding track 831 are arranged corresponding to each other by a shape correspondence as the “shape” to the “shape”. It can be also considered that the first surface 8211 is angled to the second surface 8212 by an obtuse angle, and the fifth surface 8311 is angled to the sixth surface 8312 by an obtuse angle.

The second guiding track 822 and the fourth guiding track 832 are arranged corresponding to each other by a shape correspondence as the “shape” to the “shape”. It can be also considered that the seventh surface 8321 is angled to the eighth surface 8322 by an obtuse angle, and the third surface 8221 is angled to the fourth surface 8222 by an obtuse angle.

The balls 804 are disposed between the lens carrier 802 and the base 803 for providing degrees of freedom of translational movement of the lens carrier 802 along a direction parallel to the optical axis 811 with respect to the base 803. The balls 804 include two first balls 841 and two second balls 842. The first balls 841 are disposed between the first guiding track 821 and the third guiding track 831. The second balls 842 are disposed between the second guiding track 822 and the fourth guiding track 832.

The first balls 841 have a first ball axis 8411. The first ball axis 8411 is formed by an axial movement path of the center of the first balls 841 along a direction parallel to the first guiding track 821. It can be also considered that the first ball axis 8411 is a connection line of centers of any two or more first balls 841, as shown in FIG. 36.

The second balls 842 have a second ball axis 8421. The second ball axis 8421 is formed by an axial movement path of the center of the second balls 842 along a direction parallel to the second guiding track 822. It can be also considered that the second ball axis 8421 is a connection line of centers of any two or more second balls 842, as shown in FIG. 36.

The first ball axis 8411, the second ball axis 8421 and the optical axis 811 intersect a plane perpendicular to the optical axis 811 at a first intersection point P1, a second intersection point P2 and a third intersection point P3, respectively. As shown in FIG. 38 and FIG. 39, FIG. 38 is the cross-sectional view of the camera module 8 sectioned along the P-P line in FIG. 34 in which the surface formed by the section along the P-P line is precisely the abovementioned plane perpendicular to the optical axis 811, and the first ball axis 8411, the second ball axis 8421 and the optical axis 811 intersect the abovementioned plane to respectively form the first intersection point P1, the second intersection point P2 and the third intersection point P3 in FIG. 39.

A first line L1 is defined from the first intersection point P1 to the second intersection point P2, a second line L2 is defined from the first intersection point P1 to the third intersection point P3, and a third line L3 is defined from the second intersection point P2 to the third intersection point P3, as shown in FIG. 39. A first direction R1 located on the abovementioned plane is defined as being parallel to the first line L1, and a second direction R2 located on the abovementioned plane is defined as being orthogonal to the first direction R1.

A height of each of the first guiding track 821 through the fourth guiding track 832 along the first direction R1 is greater than a height of each of the first balls 841 through the second balls 842 along the first direction R1. For example, as shown in FIG. 41, a height H11 of the fourth guiding track 832 along the first direction R1 is greater than a height H12 of single second ball 842 along the first direction R1.

A height of each of the first guiding track 821 through the fourth guiding track 832 along the second direction R2 is greater than a height of each of the first balls 841 through the second balls 842 along the second direction R2. For example, as shown in FIG. 40, a height H21 of the first guiding track 821 along the second direction R2 is greater than a height H22 of single first ball 841 along the second direction R2.

Each of the first surface 8211 through the eighth surface 8322 is in physical contact with correspondingly disposed one among the balls 804 through only one contact point. As shown in FIG. 40, the first surface 8211 is in physical contact with a correspondingly disposed first ball 841 through only one contact point CP, the second surface 8212 is in physical contact with a correspondingly disposed first ball 841 through only one contact point CP, the fifth surface 8311 is in physical contact with a correspondingly disposed first ball 841 through only one contact point CP, and the sixth surface 8312 is in physical contact with a correspondingly disposed first ball 841 through only one contact point CP. As shown in FIG. 41, the third surface 8221 is in physical contact with a correspondingly disposed second ball 842 through only one contact point CP, the fourth surface 8222 is in physical contact with a correspondingly disposed second ball 842 through only one contact point CP, the seventh surface 8321 is in physical contact with a correspondingly disposed second ball 842 through only one contact point CP, and the eighth surface 8322 is in physical contact with a correspondingly disposed second ball 842 through only one contact point CP. It can be also considered that the first guiding track 821 contacts single first ball 841 by two points, the second guiding track 822 contacts single second ball 842 by two points, the third guiding track 831 contacts single first ball 841 by two points, and the fourth guiding track 832 contacts single second ball 842 by two points.

The driving unit 805 includes two magnets 851, two coils 852 and a flexible printed circuit 853. The magnets 851 are coupled to the lens carrier 802. The coils 852 are disposed on the flexible printed circuit 853 and respectively correspond to the magnets 851. Moreover, the flexible printed circuit 853 is coupled to the lens carrier 802 and the base 803.

The magnet 851 and the lens carrier 802 together form a movable-magnet driving configuration, such that the driving unit 805 is able to stably move the lens carrier 802 with respect to the base 803 along all of the first guiding track 821 through the fourth guiding track 832 in a direction parallel to the optical axis 811. Moreover, the position configuration of each contact point CP assists in achieving a radial force balance along a direction perpendicular to the optical axis 811, such that the lens carrier 802 and the base 803 have an alignment function to each other.

When an angle between the second surface 8212 and the fourth surface 8222 is θ, the following condition is satisfied: θ=60°, wherein θ is shown as in FIG. 42.

When an angle between the sixth surface 8312 and the eighth surface 8322 is θ′, the following condition is satisfied: θ′=60°, wherein θ′ is shown as in FIG. 42.

When a distance of the second line L2 projected onto the first line L1 is D1, and a distance of the third line L3 projected onto the first line L1 is D2, the following conditions are satisfied: D1=5.5 mm; D2=5.5 mm; D1/D2=1; and D1=D2, wherein D1 and D2 are shown as in FIG. 39.

### 9th Embodiment

A camera module (not numbered) provided in this embodiment is similar to the camera module 8 provided in the previous embodiment, and therefore only difference between this and the previous embodiments, as well as necessary description, will be illustrated hereinafter.

Please refer to FIG. 43, which is a schematic view showing the position relationship between a base and balls of a camera module according to the 9th embodiment of the present disclosure. Please be noted that only the base 903 and the first balls 941 and the second balls 942 of the balls 904 are depicted in FIG. 43 for clearly showing the structure of the base 903.

In this embodiment, the third guiding track 931 of the base 903 further has a stopper 9313. The two first balls 941 disposed corresponding to the third guiding track 931 are space apart from each other by the stopper 9313. Moreover, the fourth guiding track 932 of the base 903 further has a stopper 9323. The two second balls 942 disposed corresponding to the fourth guiding track 932 are space apart from each other by the stopper 9323. Moreover, the first balls 941 have a first ball axis 9411, and the second balls 942 have a second ball axis 9421.

### 10th Embodiment

A camera module (not numbered) provided in this embodiment is similar to the camera module 8 provided in the eighth embodiment, and therefore only difference between this and the eighth embodiments, as well as necessary description, will be illustrated hereinafter.

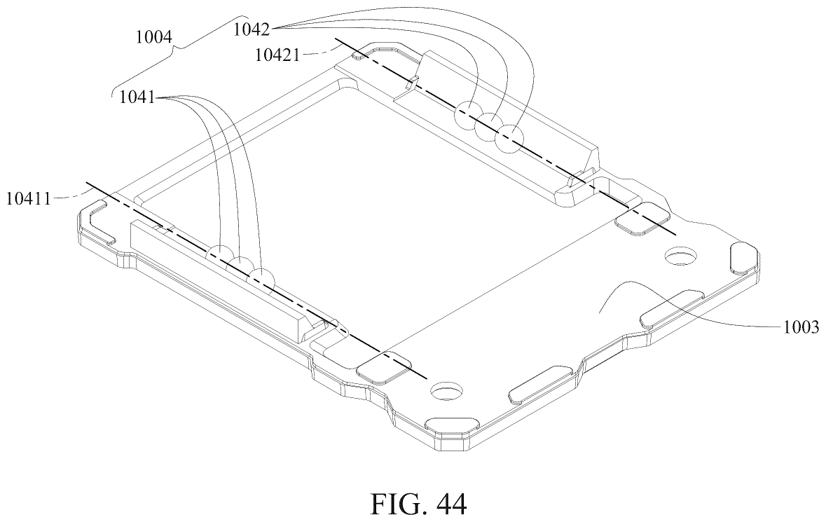

Please refer to FIG. 44, which is a schematic view showing the position relationship between abase and balls of a camera module according to the 10th embodiment of the present disclosure. Please be noted that only the base 1003 and the first balls 1041 and the second balls 1042 of the balls 1004 are depicted in FIG. 44 for clearly showing the quantity of the first balls 1041 and the second balls 1042.

In this embodiment, the quantity of the first balls 1041 is three, and the quantity of the second balls 1042 is also three. Moreover, the first balls 1041 have a first ball axis 10411, and the second balls 1042 have a second ball axis 10421.

### 11th Embodiment

A camera module (not numbered) provided in this embodiment is similar to the camera module 8 provided in the eighth embodiment, and therefore only difference between this and the eighth embodiments, as well as necessary description, will be illustrated hereinafter.

Please refer to FIG. 45, which is a schematic view showing the position relationship between a base and balls of a camera module according to the 11th embodiment of the present disclosure. Please be noted that only the base 1103 and the first balls 1141 and the second ball 1142 of the balls 1104 are depicted in FIG. 45 for clearly showing the quantity of the first balls 1141 and the second ball 1142.

In this embodiment, the quantity of the first balls 1141 is two, and the quantity of the second ball 1142 is one. Moreover, the first balls 1141 have a first ball axis 11411, and the second ball 1142 has a second ball axis 11421.

### 12th Embodiment

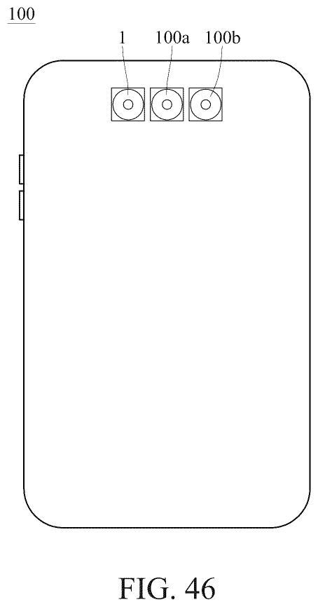

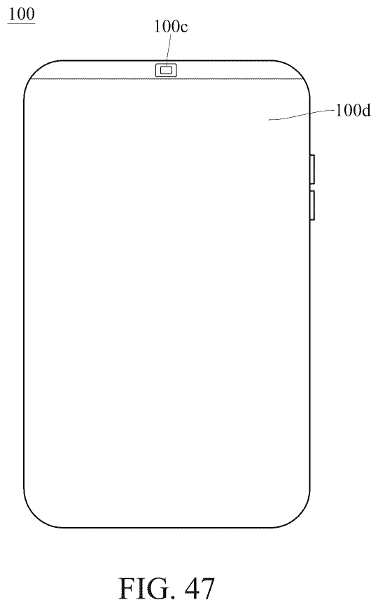

FIG. 46 is a perspective view of an electronic device according to the 12th embodiment of the present disclosure. FIG. 47 is another perspective view of the electronic device in FIG. 46.

In this embodiment, an electronic device 100 is a smartphone including the camera module 1 disclosed in the 1st embodiment, a camera module 100a, a camera module 100b, a camera module 100c, a display module 100d and an image sensor (not shown) that is disposed on the image surface 1c of the camera module 1 for transferring an electrical signal converted from an optical signal of the imaging.

As shown in FIG. 46, the camera module 1, the camera module 100a and the camera module 100b are disposed on the same side of the electronic device 100 and face the same side, and each of the camera modules 1, 100a and 100b has a single focal point. As shown in FIG. 47, the camera module 100c and the display module 100d are disposed on the opposite side of the electronic device 100. Furthermore, each of the camera modules 100a, 100b and 100c can have a configuration similar to that of the camera module 1. In detail, each of the camera modules 100a, 100b and 100c can include one of the camera modules disclosed in the 1st through 11th embodiments of the present disclosure, with an image sensor disposed on an image surface of the camera module 100a, 100b or 100c.

Moreover, as shown in FIG. 47, the camera module 100c can have a non-circular opening, and the lens barrel or the lens elements in the camera module 100c can have one or more trimmed edges at outer diameter positions thereof for corresponding to the non-circular opening, such as the appearance of the camera module 8 disclosed in the 8th embodiment of the present disclosure. Therefore, it is favorable for further reducing the length of the camera module 100c along single axis, thereby reducing the overall size of the lens, increasing the area ratio of the display module 100d with respect to the electronic device 100. In this embodiment, the electronic device 100 includes multiple camera modules 1, 100a, 100b and 100c, but the present disclosure is not limited to the number and arrangement of camera modules.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens driving module comprising:
an imaging lens having an optical axis;
a lens carrier configured to mount the imaging lens, wherein the lens carrier comprises:
a first guiding track extending along a direction parallel to the optical axis, wherein the first guiding track has:
a first surface; and
a second surface connected to the first surface, wherein the first surface is angled to the second surface; and
a second guiding track extending along a direction parallel to the optical axis, wherein the second guiding track has:
a third surface; and
a fourth surface connected to the third surface, wherein the third surface is angled to the fourth surface;
a base disposed corresponding to the lens carrier, wherein the base comprises:
a third guiding track extending along a direction parallel to the optical axis, wherein the third guiding track is disposed corresponding to the first guiding track, and the third guiding track has:
a fifth surface; and
a sixth surface connected to the fifth surface, wherein the fifth surface is angled to the sixth surface; and
a fourth guiding track extending along a direction parallel to the optical axis, wherein the fourth guiding track is disposed corresponding to the second guiding track, and the fourth guiding track has:
a seventh surface; and
an eighth surface connected to the seventh surface, wherein the seventh surface is angled to the eighth surface;
a plurality of balls disposed between the lens carrier and the base, wherein the plurality of balls comprises:
at least one first ball disposed between the first guiding track and the third guiding track; and
at least one second ball disposed between the second guiding track and the fourth guiding track; and
a driving unit configured to move the lens carrier with respect to the base along a direction parallel to the optical axis, wherein the driving unit comprises:
at least one magnet; and
at least one coil disposed corresponding to the at least one magnet;
wherein one of the at least one magnet and the at least one coil is coupled to the lens carrier;
wherein each of the first surface through the eighth surface is in physical contact with correspondingly disposed one among the plurality of balls through only one contact point;
wherein an angle between the second surface and the fourth surface is θ, and the following condition is satisfied:
$$0 ° \leq θ < 130 ° .$$

2. The imaging lens driving module according to claim 1, wherein a quantity of the at least one first ball is at least two.

3. The imaging lens driving module according to claim 2, wherein a quantity of the at least one second ball is at least two.

4. The imaging lens driving module according to claim 2, wherein the third guiding track of the base further has a stopper, and the at least two first balls disposed corresponding to the third guiding track are spaced apart from each other by the stopper.

5. The imaging lens driving module according to claim 2, wherein a quantity of the at least one second ball is only one.

6. The imaging lens driving module according to claim 1, wherein the at least one first ball has a first ball axis that is formed by an axial movement path of a center of the at least one first ball along a direction parallel to the first guiding track.

7. The imaging lens driving module according to claim 6, wherein the at least one second ball has a second ball axis that is formed by an axial movement path of a center of the at least one second ball along a direction parallel to the second guiding track.

8. The imaging lens driving module according to claim 7, wherein the first ball axis, the second ball axis and the optical axis intersect a plane perpendicular to the optical axis at a first intersection point, a second intersection point and a third intersection point, respectively.

9. The imaging lens driving module according to claim 8, wherein a first line is defined from the first intersection point to the second intersection point, a second line is defined from the first intersection point to the third intersection point, a third line is defined from the second intersection point to the third intersection point, a first direction located on the plane is defined as being parallel to the first line, and a second direction located on the plane is defined as being orthogonal to the first direction.

10. The imaging lens driving module according to claim 9, wherein a height of each of the first guiding track through the fourth guiding track along the first direction is greater than a height of each of the at least one first ball through the at least one second ball along the first direction.

11. The imaging lens driving module according to claim 9, wherein a height of each of the first guiding track through the fourth guiding track along the second direction is greater than a height of each of the at least one first ball through the at least one second ball along the second direction.

12. The imaging lens driving module according to claim 9, wherein a distance of the second line projected onto the first line is D1, a distance of the third line projected onto the first line is D2, and the following condition is satisfied:
$$1.05 \leq D 1 / D 2 < 6 .$$

13. The imaging lens driving module according to claim 9, wherein a distance of the second line projected onto the first line is D1, a distance of the third line projected onto the first line is D2, and the following condition is satisfied:
$$D 1 = D 2.$$

14. The imaging lens driving module according to claim 1, wherein the first surface is angled to the fifth surface.

15. The imaging lens driving module according to claim 1, wherein the driving unit further comprises:
a flexible printed circuit on which the at least one coil is disposed.

16. The imaging lens driving module according to claim 15, wherein the flexible printed circuit is coupled to the lens carrier.

17. A camera module comprising:
the imaging lens driving module of claim 1.

18. An electronic device comprising:
the camera module of claim 17; and
an image sensor disposed on an image surface of the camera module.

19. An imaging lens driving module comprising:
an imaging lens having an optical axis;
a lens carrier configured to mount the imaging lens, wherein the lens carrier comprises:
a first guiding track extending along a direction parallel to the optical axis, wherein the first guiding track has:
a first surface; and
a second surface connected to the first surface, wherein the first surface is angled to the second surface; and
a second guiding track extending along a direction parallel to the optical axis, wherein the second guiding track has:
a third surface; and
a fourth surface connected to the third surface, wherein the third surface is angled to the fourth surface;
a base disposed corresponding to the lens carrier, wherein the base comprises:
a third guiding track extending along a direction parallel to the optical axis, wherein the third guiding track is disposed corresponding to the first guiding track, and the third guiding track has:
a fifth surface; and
a sixth surface connected to the fifth surface, wherein the fifth surface is angled to the sixth surface; and
a fourth guiding track extending along a direction parallel to the optical axis, wherein the fourth guiding track is disposed corresponding to the second guiding track, and the fourth guiding track has:
a seventh surface; and
an eighth surface connected to the seventh surface, wherein the seventh surface is angled to the eighth surface;
a plurality of balls disposed between the lens carrier and the base, wherein the plurality of balls comprises:
at least one first ball disposed between the first guiding track and the third guiding track; and
at least one second ball disposed between the second guiding track and the fourth guiding track; and
a driving unit configured to move the lens carrier with respect to the base along a direction parallel to the optical axis, wherein the driving unit comprises:
at least one magnet; and
at least one coil disposed corresponding to the at least one magnet;
wherein one of the at least one magnet and the at least one coil is coupled to the lens carrier;
wherein each of the first surface through the eighth surface is in physical contact with correspondingly disposed one among the plurality of balls through only one contact point;
wherein an angle between the sixth surface and the eighth surface is θ′, and the following condition is satisfied:
$$0 ° \leq θ ’ < 130 ° .$$

20. The imaging lens driving module according to claim 19, wherein a quantity of the at least one first ball is at least two.

21. The imaging lens driving module according to claim 20, wherein a quantity of the at least one second ball is at least two.

22. The imaging lens driving module according to claim 21, wherein the fourth guiding track of the base further has a stopper, and the at least two second balls disposed corresponding to the fourth guiding track are spaced apart from each other by the stopper.

23. The imaging lens driving module according to claim 20, wherein a quantity of the at least one second ball is only one.

24. The imaging lens driving module according to claim 19, wherein the at least one first ball has a first ball axis that is formed by an axial movement path of a center of the at least one first ball along a direction parallel to the first guiding track.

25. The imaging lens driving module according to claim 24, wherein the at least one second ball has a second ball axis that is formed by an axial movement path of a center of the at least one second ball along a direction parallel to the second guiding track.

26. The imaging lens driving module according to claim 25, wherein the first ball axis, the second ball axis and the optical axis intersect a plane perpendicular to the optical axis at a first intersection point, a second intersection point and a third intersection point, respectively.

27. The imaging lens driving module according to claim 26, wherein a first line is defined from the first intersection point to the second intersection point, a first direction located on the plane is defined as being parallel to the first line, and a second direction located on the plane is defined as being orthogonal to the first direction.

28. The imaging lens driving module according to claim 27, wherein a height of each of the first guiding track through the fourth guiding track along the first direction is greater than a height of each of the at least one first ball through the at least one second ball along the first direction.

29. The imaging lens driving module according to claim 27, wherein a height of each of the first guiding track through the fourth guiding track along the second direction is greater than a height of each of the at least one first ball through the at least one second ball along the second direction.

30. The imaging lens driving module according to claim 19, wherein the second surface is angled to the sixth surface.

31. An imaging lens driving module comprising:
an imaging lens having an optical axis;
a lens carrier configured to mount the imaging lens, wherein the lens carrier comprises:
a first guiding track extending along a direction parallel to the optical axis, wherein the first guiding track has:
a first surface; and
a second surface connected to the first surface, wherein the first surface is angled to the second surface; and
a second guiding track extending along a direction parallel to the optical axis, wherein the second guiding track has:
a third surface; and
a fourth surface connected to the third surface, wherein the third surface is angled to the fourth surface;
a base disposed corresponding to the lens carrier, wherein the base comprises:
a third guiding track extending along a direction parallel to the optical axis, wherein the third guiding track is disposed corresponding to the first guiding track, and the third guiding track has:
a fifth surface; and
a sixth surface connected to the fifth surface, wherein the fifth surface is angled to the sixth surface; and
a fourth guiding track extending along a direction parallel to the optical axis, wherein the fourth guiding track is disposed corresponding to the second guiding track, and the fourth guiding track has:
a seventh surface; and
an eighth surface connected to the seventh surface, wherein the seventh surface is angled to the eighth surface;
a plurality of balls disposed between the lens carrier and the base, wherein the plurality of balls comprises:
at least one first ball disposed between the first guiding track and the third guiding track; and
at least one second ball disposed between the second guiding track and the fourth guiding track; and
a driving unit configured to move the lens carrier with respect to the base along a direction parallel to the optical axis, wherein the driving unit comprises:
at least one magnet; and
at least one coil disposed corresponding to the at least one magnet;
wherein one of the at least one magnet and the at least one coil is coupled to the lens carrier;
wherein each of the first surface through the eighth surface is in physical contact with correspondingly disposed one among the plurality of balls through only one contact point.

32. The imaging lens driving module according to claim 31, wherein a quantity of the at least one first ball is at least two.

33. The imaging lens driving module according to claim 32, wherein a quantity of the at least one second ball is at least two.

34. The imaging lens driving module according to claim 31, wherein the at least one first ball has a first ball axis that is formed by an axial movement path of a center of the at least one first ball along a direction parallel to the first guiding track.

35. The imaging lens driving module according to claim 34, wherein the at least one second ball has a second ball axis that is formed by an axial movement path of a center of the at least one second ball along a direction parallel to the second guiding track.

36. The imaging lens driving module according to claim 35, wherein the first ball axis, the second ball axis and the optical axis intersect a plane perpendicular to the optical axis at a first intersection point, a second intersection point and a third intersection point, respectively.

37. The imaging lens driving module according to claim 36, wherein a first line is defined from the first intersection point to the second intersection point, a second line is defined from the first intersection point to the third intersection point, and a third line is defined from the second intersection point to the third intersection point.

38. The imaging lens driving module according to claim 37, wherein a distance of the second line projected onto the first line is D1, a distance of the third line projected onto the first line is D2, and the following condition is satisfied:
$$1.05 \leq D 1 / D 2 < 6 .$$

39. The imaging lens driving module according to claim 37, wherein a distance of the second line projected onto the first line is D1, a distance of the third line projected onto the first line is D2, and the following condition is satisfied:
$$D 1 = D 2.$$
